(19) United States
(12) Patent Application Publication
(10) Pub. No.: US 2012/0237257 A1
(43) Pub. Date: Sep. 20, 2012

(54) COLOR IMAGE FORMING APPARATUS

(75) Inventors: Toshiaki TOMINO, Tokyo (JP); Motoji KAWAMOTO, Tokyo (JP); Shinobu KONNO, Tokyo (JP)

(73) Assignee: KONICA MINOLTA BUSINESS TECHNOLOGIES, INC., Tokyo (JP)

(21) Appl. No.: 13/416,003

(22) Filed: Mar. 9, 2012

(30) Foreign Application Priority Data
Mar. 18, 2011 (JP) 2011-060024
Mar. 18, 2011 (JP) 2011-060025
Mar. 18, 2011 (JP) 2011-060026

(51) Int. Cl. G03G 15/08

(52) U.S. Cl. 399/121

(57) ABSTRACT

A color image forming apparatus includes: a main body of the apparatus that forms a color image; and an intermediate transfer unit for transferring the color image formed by the main body of the apparatus, wherein the intermediate transfer unit is configured to be removed from and to be inserted into the main body of the apparatus, and wherein the intermediate transfer unit is configured to perform a door-like opening and closing movement.

### RELATED APPLICATION

This application is based on Japanese Patent Application Nos. 2011-60024 filed on Mar. 18, 2011, 2011-60025 filed on Mar. 18, 2011, and 2011-60026 filed on Mar. 18, 2011, in the Japanese Patent Office, each of which is hereby incorporated by reference in its entirety herein.

### BACKGROUND

1. Field of the Invention

The present invention relates to a color image forming apparatus suited for application to a vertical tandem type color printer, color photocopier and color multi-functional peripherals thereof which are provided with a large-sized intermediate transfer unit and are used to form a color image.

2. Description of Related Art

In recent years, there has been a growing opportunity of using a color printer for forming a color image based on the color image information, a color multi-functional peripheral equipped with a scanning function of scanning the image of a document and outputting the image signal for color image reproduction, and many such similar multi-functional peripherals. One of the widely used printers is a digital color printer for forming a color image from an external device of a personal computer or the like, based on the image data of red (R), green (G) and blue (B).

In this type of printer, one of the color printer using electrophotographic processes is provided with an image forming section for forming an color toner image based on the image data of yellow (Y), magenta (M), cyan (C) and black (BK) subsequent to color conversion of the RGB-based image data. The image forming section is provided with an image forming unit in charge of each of Y-, M-, C- and BK-color image forming and outputting functions. Based on the image data, an electrostatic latent image is formed on the photoreceptor drum uniformly charged by a charging device for each image color by means of a scanning and exposure section using a polygon mirror.

This electrostatic latent image is developed by a developer for each image color. Subsequent to operations such as charging, exposure and development, the color toner images formed on the photoreceptor drum are superimposed on one another, for example, on the intermediate transfer belt. The color toner image formed by superimposition is transferred onto the sheet material (paper) by the transfer section. The toner image transferred onto a prescribed transfer material is fixed by a fixing section, with the result that the color image based on the image data is formed on the prescribed sheet material.

The aforementioned intermediate transfer belt, belt cleaner and roller are unitized and are formed into an intermediate transfer unit in many cases. In many of the tandem type color image forming apparatuses equipped with an intermediate transfer unit, the intermediate transfer unit can be removed from or inserted into the main body.

The structure of removing and inserting the intermediate transfer unit can be classified into a structure that permits the photoreceptor drum unit to be mounted or dismounted from the intermediate transfer unit for the purpose of facilitating maintenance of the intermediate transfer belt, belt cleaner and roller, a structure that permits the belt to be replaced by removal of the front panel, a structure that allows the intermediate transfer unit to be opened or closed in the vertical direction, a structure that ensures the intermediate transfer unit to be opened or closed together with the side cover, and a structure that allows the intermediate transfer unit to be removed from the top surface of the main body.

The image forming apparatus having the structure that permits the photoreceptor drum unit to be mounted or dismounted from the intermediate transfer unit is disclosed in the Unexamined Japanese Patent Application Publication No. 2005-037677 (FIG. 3 and page 8). This image forming apparatus is provided with a photoreceptor drum unit, intermediate transfer unit, support frame, suspension means and mounting/dismounting means. A toner image is formed on the photoreceptor drum unit. The toner image formed on the photoreceptor drum unit is fed to the transfer sheet by the intermediate transfer unit. The intermediate transfer unit is mounted on the support frame. The suspension means is arranged opposed to the intermediate transfer unit, and the photoreceptor drum unit is suspended on the support frame on which the intermediate transfer unit is mounted. The mounting/dismounting means is mounted on the support frame, and operates in such a way as to allow the support frame to be removed from or inserted into the main body. Use of such a unit suspension structure ensures easy maintenance and replacement of the intermediate transfer unit and photoreceptor drum unit.

The Unexamined Japanese Patent Application Publication No. 2009-092806 (FIG. 9 and page 7) discloses an image forming apparatus having the structure that permits the belt to be replaced. This image forming apparatus is provided with an image forming main body, intermediate transfer unit and tension adjusting mechanism. The intermediate transfer unit has a front panel and intermediate transfer belt. The tension adjusting mechanism is installed on the intermediate transfer unit and is operated to increase or decrease the tension of the intermediate transfer belt. The intermediate transfer unit is supported so as to slide between the position set on the image forming main body and the position for replacing the belt pulled out of the image forming main body.

Based on the aforementioned conditions, the front panel is removed and the intermediate transfer unit is pulled out to the belt replacement position. With the tension of the intermediate transfer belt loosened by the tension adjusting mechanism, the intermediate transfer belt is moved in and out in the direction of the belt. Easy replacement of an intermediate transfer belt is provided by such as a belt replacement structure.

Further, an image forming apparatus based on the structure that allows the intermediate transfer unit to be opened or closed in the vertical direction is disclosed in the Unexamined Japanese Patent Application Publication No. 2005-309036 (FIG. 12 and page 6). This image forming apparatus is provided with a photoreceptor, conveyance means, transfer unit, the sliding mechanism, support frame, the rotary hinge, damper member and main body frame. The transfer unit has a transfer means. The transfer means is arranged in such a way as to abut on the photoreceptor on the surface of which a developer image is fanned, through the belt conveyed by a conveyance means.

The main body frame is provided with a sliding mechanism. This sliding mechanism is movably provided with a support frame. The support frame supports a transfer unit and holds a transfer unit in position in the traveling direction between the transfer working position and non-transfer working position. This support frame includes a rotary hinge that can be rotated. A damper member is installed at the position interlocked with the rotary motion of the transfer unit. A damper member operates in the direction wherein the transfer unit rotates and falls down under its own weight under this condition. This structure of the image forming apparatus ensures the safety of the operator performing maintenance work and prevents the apparatus from being damaged.

The Unexamined Japanese Patent Application Publication No. 2005-162492 (FIG. 3 and page 7) discloses an image forming apparatus of the structure that allows the intermediate transfer unit to be opened or closed together with the side covet This image forming apparatus includes a main body, sheet conveyance means, image forming section, side cover, reversing means and sheet re-feed means. The sheet conveyance means feeds the sheet toward the image forming section approximately in the vertical direction. The image forming section forms an image on the sheet conveyed by the sheet conveyance means.

In the meantime, the side cover is arranged to open and close freely with respect to the main body, and is designed to hold the sheet conveyance means. The reversing means reverses the sheet on one side of which an image has been formed. The sheet re-feed means feeds the sheet reversed by the reversing means to the position upstream of the sheet conveyance means. The sheet re-feed means is formed integral with the side cover under these conditions, and the sheet conveyance means is mounted removably from the side cover.

When the side cover is opened from the main body, the sheet conveyance path by the sheet conveyance means is opened, the sheet in the sheet re-feed means can be taken out of the side wherein the sheet conveyance means is mounted on the side cover. This arrangement of the image forming apparatus eliminates the need of providing a duplexing unit function outside the side cover and simplifies the structure, thereby enhancing the maneuverability when solving a paper jam problem.

The Unexamined Japanese Patent Application Publication No. 2002-062743 (FIG. 3 and page 5) discloses an image forming apparatus based on the structure that allows the intermediate transfer unit to be removed from the top surface of the apparatus proper. This image forming apparatus has an image forming section and intermediate transfer unit. The image forming section forms a toner image on each of a plurality of image carriers in conformity to the input image. The intermediate transfer unit has an intermediate transfer belt. The toner image formed by the image forming section is superimposed on the relevant intermediate transfer belt, and the superimposed toner image is transferred onto the transfer material.

In the intermediate transfer unit, the intermediate transfer belt is applied to the upper and lower rollers, and is fed in the vertical direction. The intermediate transfer unit is composed of the intermediate transfer belt and upper and lower rollers that are formed in an integrated configuration. The intermediate transfer unit can be removed from the top of the main body under this condition. The image forming apparatus formed in this arrangement allows the intermediate transfer belt to be replaced in the intermediate transfer mounted or dismounted from the top of the main body.

The following problems have been found in the color image forming apparatus equipped with an intermediate transfer unit according to the conventional example, during the maintenance of the intermediate transfer belt, belt cleaner and roller.

i) In the image forming apparatus of the Unexamined Japanese Patent Application Publication No. 2005-037677, the photoreceptor drum unit can be mounted or dismounted from the intermediate transfer unit. However, the size of the intermediate transfer unit has been increased due to an increase in the number of colors (from four to six colors) in the color developing section. Thus, the photoreceptor drum unit cannot be mounted or dismounted due to an increase in the weight of the intermediate transfer unit.

ii) In the image forming apparatus of the Unexamined Japanese Patent Application Publication No. 2009-092806, the belt can be replaced by removing the front panel. However, this structure requires removal of the front panel as a reference for positioning. This has a problem of complicating the work procedure in re-positioning the front panel after the belt has been replaced.

iii) In the image forming apparatus of the Unexamined Japanese Patent Application Publication No. 2005-309036, the intermediate transfer unit can be opened or closed in the vertical direction. However, the worker is required to look into the intermediate transfer unit developed in the vertical direction at the time of maintenance.

iv) In the image forming apparatus of the Unexamined Japanese Patent Application Publication No. 2005-162492 (FIG. 3 and page 7), the intermediate transfer unit can be opened or closed together with the side cover of the main body. However, when a large-sized sheet feed device is connected to the side of the main body, the large-sized sheet feed device has to be removed from the side of the main body every time a paper jam problem is to be solved.

v) In the image forming apparatus of the Unexamined Japanese Patent Application Publication No. 2002-062743, the intermediate transfer unit can be mounted or dismounted from the top surface of the main body. However, the size of the intermediate transfer unit is increased as the number of colors is increased in the color developing section. Mounting and dismounting work will be difficult due to the increased weight of the intermediate transfer unit.

vi) Assume that the aforementioned image forming apparatus uses a complex mounting structure (hereinafter referred to as “composite unit”) wherein the intermediate transfer unit, photoreceptor drum unit and others are integrated into one unit, which is mounted on the main body. In this case, if the composite unit is mounted on the main body without taking any effective means at the time of mounting, positioning between the two units will be difficult subsequent to mounting, depending on the state of fixing between these units.

vii) Assume that the aforementioned image forming apparatus uses a structure wherein the intermediate transfer unit is open to the main body. This requires some means to be provided to protect against possible interference with the main body when the intermediate transfer unit is opened. However, interference preventing protrusions are provided on the side of the main body, a serious impact may be given to the external design. If interference preventing protrusions are formed on the side of the intermediate transfer unit, a problem will arise when the intermediate transfer belt is removed from the intermediate transfer unit. Further, it may be possible to install a stopper on the rotary fulcrum of the intermediate transfer unit. However, the stopper will be subjected to excessive stress due to rotary moment, and may be damaged.

### SUMMARY

In view of the problems described above, it is an object of the present invention to provide a color image forming apparatus capable of ensuring easy replacement of an intermediate transfer belt and others, using an improved method for pulling out an intermediate transfer unit, despite a possible increase in the unit size.

It is another object of the present invention to provide a color image forming apparatus capable of ensuring easy mounting of a composite unit consisting of an intermediate transfer unit and rack unit on the main body, using an improved structure for mounting the intermediate transfer unit, despite a possible increase in the unit size.

It is a further object of the present invention to provide a color image forming apparatus capable of preventing possible interference between the main body and intermediate transfer unit, and protecting a transfer belt when an intermediate transfer unit is opened, wherein the present invention solves all the aforementioned problems.

The above-mentioned problems can be solved by the following structures:

1. A color image forming apparatus includes: a main body of the apparatus that forms a color image; and an intermediate transfer unit for transferring the color image formed by the main body of the apparatus, wherein the intermediate transfer unit is configured to be removed from and to be inserted into the main body of the apparatus, and wherein the intermediate transfer unit is configured to perform a door-like opening and closing movement.

In the color image forming apparatus of this item, the main body of the apparatus forms a color image and the intermediate transfer unit transfers the image formed by the main body of the apparatus. Under this condition, the intermediate transfer unit can be removed from or inserted into the main body of the apparatus, and has a door-like function of opening and closing in the horizontal direction. This structure allows the intermediate transfer unit to be opened or closed like a door, with the intermediate transfer unit removed from the main body of the apparatus at the time of belt replacement, and permits the intermediate transfer belt to be replaced, without having to dismount from the main body of the apparatus the intermediate transfer unit that may be difficult to remove due to an increase in the size of the color image forming apparatus.

2. The color image forming apparatus of item 1, wherein the main body of the apparatus comprises a rack unit for image forming which, together with the intermediate transfer unit, configured to be removed from and inserted into the main body apparatus.

3. The color image forming apparatus of item 2, wherein the intermediate transfer unit is mounted in such a way as to perform a door-like opening and closing movement in the horizontal direction through a rotary hinge section provided on a back side of the rack unit.

4. The color image forming apparatus of item 2, wherein the intermediate transfer unit is mounted in such a way as to perform a door-like opening and closing movement in the horizontal direction through the rotary hinge section provided on a front side of the rack unit.

5. The color image forming apparatus of item 3, wherein a gap adjusting play for adjusting a position gap between the intermediate transfer unit and the rack unit in a vertical direction and a lateral direction is arranged.

6. The color image forming apparatus of item 5, wherein a temporary fixing mechanism is installed between the rack unit and the intermediate transfer unit, and the temporary fixing mechanism is provided with the gap adjusting play.

This structure provides the function of a rough guide when a composite unit consisting of an intermediate transfer unit and rack unit is mounted on the main body of the apparatus, and avoids possible interface between the intermediate transfer belt and photoreceptor drum, and between the main body of the apparatus and intermediate transfer unit.

7. The color image forming apparatus of item 6, wherein the temporary fixing mechanism further comprises a magnetic member mounted on the rack unit for attracting the intermediate transfer unit, and the magnetic member comprises a gap adjusting play for adjusting a position gap between the intermediate transfer unit and the rack unit in a unit attracting direction which is assumed as a direction of attracting the intermediate transfer unit.

8. The color image forming apparatus of item 7, wherein the temporary fixing mechanism is provided with a function of adjusting the position gap in the unit attracting direction.

9. The color image forming apparatus of item 2, wherein the rotary hinge section is installed on each of the top and bottom of the back side of the rack unit, and each of the rotary hinge sections on the top and bottom is provided with a positioning gap absorbing damper member.

10. The color image forming apparatus of item 2, wherein the main body of apparatus comprises a rear panel and the intermediate transfer unit comprises a front panel, wherein a plurality of penetration shafts for positioning are fixed at prescribed positions of the rear panel and a plurality of bearing sections for positioning are provided at prescribed positions of the front panel at which each top of the plurality of penetration shafts are exposable, and wherein the color image forming apparatus being provided with a positioning mechanism in which each top end of the exposed penetration shafts is engaged with the bearing sections or a plurality of engaging members are engaged with the bearing sections.

11. A color image forming apparatus including: a main body; a rack unit installed in the main body for color image forming; and an intermediate transfer unit for transferring the color image formed by the rack unit, wherein the rack unit is configured to be removed from and to be inserted into the main body of the apparatus, and wherein the rack unit is configured to perform a door-like opening and closing movement.

In the color image forming apparatus of item 11, the rack unit is mounted inside the main body of the apparatus to form a color image. The intermediate transfer unit transfers the image formed by the rack unit. The rack unit is structured in such a way that the removal/insertion operation of the intermediate transfer unit and main body of the apparatus are performed under this condition and the door-like opening and closing operation in the horizontal direction can be performed. This structure allows the door-like opening and closing operation of the rack unit to be performed with the intermediate transfer unit pulled out of the main body of the apparatus at the time of replacement of the photoreceptor drum, and permits the photoreceptor drum to be replaced, without having to dismount from the main body of the apparatus the rack unit that may be difficult to remove due to an increase in the size of the color image forming apparatus.

12. The color image forming apparatus of item 11, wherein the rack unit is mounted in such a way as to be opened and closed freely like a door in the horizontal direction through a rotary hinge section provided on a furthest side of the intermediate transfer unit.

13. The color image forming apparatus of item 11, wherein the rack unit is mounted in such a way as to be opened and closed freely like a door in the horizontal direction through a rotary hinge section provided on a front side of the intermediate transfer unit.

14. The color image forming apparatus of item 1 including an opening amount regulating member for regulating an opening amount of the intermediate transfer unit.

In the color image forming apparatus of item 14, a color image is formed by the main body of the apparatus. The intermediate transfer unit has a transfer belt and transfers the color image formed by the main body of the apparatus onto the transfer belt. The intermediate transfer unit can be removed from or inserted into the main body of the apparatus, and can be opened like a door in the horizontal direction. Further, the intermediate transfer unit has an opening amount regulating member. This arrangement allows the opening amount regulating member to regulate the amount of opening of the intermediate transfer unit.

When the intermediate transfer unit is opened from the main body of the apparatus, this structure ensures the opening operation of the intermediate transfer unit to be refracted to the position immediately before collision with the main body of the apparatus. This avoids interference between the main body of the apparatus and intermediate transfer unit, without causing trouble during belt replacement.

15. The color image forming apparatus of item 14 wherein, when the intermediate transfer unit is opened from the main body of the apparatus, the opening amount regulating member projects from a position at which regulating member is contained within a transfer belt of the intermediate transfer unit and interferes with the main body of the apparatus.

16. The color image forming apparatus of item 15 including an interlocking section for projecting the opening amount regulating member synchronously with an opening/closing operation of the intermediate transfer unit.

17. The color image forming apparatus of item 16, wherein the interlocking section includes a first link mechanism for rotating the opening amount regulating member according to an angle for opening the intermediate transfer unit.

18. The color image forming apparatus of item 16, wherein the interlocking section includes a second link mechanism for moving the opening amount regulating member to a unit interference limit position, wherein the unit interference limit position corresponds to a limit position at which the intermediate transfer member does not interfere with the main body of the apparatus in a case where the intermediate transfer unit is opened.

In the color image forming apparatus of item 1, this apparatus includes an intermediate transfer unit that can be removed from or inserted into the main body of the apparatus and can be opened or closed like a door in the horizontal direction.

This structure allows the intermediate transfer unit to be opened or closed like a door, with the intermediate transfer unit kept pulled out of the main body of the apparatus, and permits the intermediate transfer belt and others to be replaced, without having to dismount from the main body of the apparatus the intermediate transfer unit that may be difficult to remove due to an increase in the size of the color image forming apparatus. Further, the operator in the standing position is allowed to overlook the entire unit and to have easy access to both sides, front and back side of the unit to perform manual maintenance work. This signifies a drastic improvement in the maintainability.

In the color image forming apparatus of item 2, this apparatus includes an image forming rack unit that, together with the intermediate transfer unit, can be removed from or inserted into the main body of the apparatus. This structure allows the door-like opening and closing operation of the intermediate transfer unit to be performed with respect to the rack unit.

In the color image forming apparatus of item 3, the intermediate transfer unit is mounted so as to be freely opened or closed in the horizontal direction like a door through the rotary hinge section installed on the furthest side of the rack unit. This structure allows the intermediate transfer belt and others to be replaced, without having to dismount the intermediate transfer unit from the main body of the apparatus.

In the color image forming apparatus of item 4, the intermediate transfer unit is mounted so as to be freely opened or closed in the horizontal direction like a door through the rotary hinge section installed on the nearest side of the rack unit. This structure allows the intermediate transfer belt and others to be replaced, without having to dismount the intermediate transfer unit from the main body of the apparatus.

In the color image forming apparatus of item 5, a misregistration gap adjusting play is provided in the horizontal and lateral directions of the rotary hinge section. This ensures high-precision positioning of the intermediate transfer unit by the penetration shaft.

In the color image forming apparatus of item 6, a temporary fixing mechanism is installed between the rack unit for forming a color image and an intermediate transfer unit which, together the rack unit, can be removed from or inserted into the main body of the apparatus and can be opened or closed like a door in the horizontal direction. This temporary fixing mechanism has a misregistration gap adjusting play.

This structure provides a function of a rough guide when a composite unit consisting of an intermediate transfer unit and rack unit is mounted on the main body of the apparatus, thereby avoiding interface between the intermediate transfer belt and photoreceptor drum or the interface between the main body of the apparatus and intermediate transfer unit. Further, a composite unit consisting of an intermediate transfer unit and rack unit can be easily mounted on the main body of the apparatus, despite a possible increase in the size and weight of the intermediate transfer unit.

In the color image forming apparatus of item 7, the rack unit is provided with a temporary fixing mechanism including a magnetic member. At the time of suction of the intermediate transfer unit, the magnetic member has a misregistration gap adjusting play in the unit attracting direction. This provides the function of a rough guide when the composite unit consisting of an intermediate transfer unit and rack unit is mounted on the main body of the apparatus.

In the color image forming apparatus of item 8, the temporary fixing mechanism has a function of adjusting the misregistration gap in the unit attracting direction. Thus, when a composite unit consisting of an intermediate transfer unit and rack unit is mounted on the main body of the apparatus, this structure ensures fine adjustment of the rough guide function.

In the color image forming apparatus of item 9, the load received by the penetration shaft at the time of mounting is supported by the damper member so that easier mounting and reduced wear of the bearing section are provided.

In the color image forming apparatus of item 10, the composite unit consisting of an intermediate transfer unit and rack unit is automatically adjusted to the main body of the apparatus in a self-alignment structure. Moreover, this structure eliminates the need of mounting or removing the front panel as a reference for positioning so that the positioning stability is enhanced.

In the color image forming apparatus of item 11, this apparatus is provided with the rack unit which together with the intermediate transfer unit can be removed from or inserted into the main body of the apparatus and can be opened or closed like a door in the horizontal direction.

This structure allows the rack unit to be opened or closed like a door, with the intermediate transfer unit kept pulled out of the main body of the apparatus, and permits the photoreceptor drum and others to be replaced, without having to dismount from the main body of the apparatus the rack unit that may be difficult to remove due to an increase in the size of the color image forming apparatus. Further, the operator in the standing position is allowed to overlook the entire unit and to have easy access to both sides, front and back of the unit to perform manual maintenance work. This signifies a drastic improvement in the maintainability.

In the color image forming apparatus of item 12, the rack unit is mounted so as to be freely opened or closed in the horizontal direction like a door through the rotary hinge section installed on the furthest side of the intermediate transfer unit. This structure allows the photoreceptor drum and others to be replaced, without having to dismount the rack unit from the main body of the apparatus.

In the color image forming apparatus of item 13, the rack unit is mounted so as to be freely opened or closed in the horizontal direction like a door through the rotary hinge section installed on the nearest side of the intermediate transfer unit. This structure allows the photoreceptor drum and others to be replaced, without having to dismount the rack unit from the main body of the apparatus.

In the color image forming apparatus of item 14, this apparatus is provided with the intermediate transfer unit that can be removed from or inserted into the main body of the apparatus and can be opened or closed like a door in the horizontal direction. This intermediate transfer unit includes an opening regulation member that regulates the degree of opening of the intermediate transfer unit.

When the intermediate transfer unit is opened from the main body of the apparatus, this structure ensures the opening operation of the intermediate transfer unit to be regulated to the position immediately before collision with the main body of the apparatus. This avoids interference between the main body of the apparatus and intermediate transfer unit, without causing trouble during belt replacement. Moreover, the transfer belt can be protected when the intermediate transfer unit is opened.

In the color image forming apparatus of item 15, when the intermediate transfer unit is opened, the opening regulation member projects from the position which contains the transfer belt and interferes with the main body of the apparatus. This arrangement ensures the opening of the intermediate transfer unit to be restricted to the position immediately before collision with the main body of the apparatus.

In the color image forming apparatus of item 16, this apparatus has an interlocking section for projecting the opening regulation member synchronously with the opening/closing operation of the intermediate transfer unit. When the intermediate transfer unit opens, this arrangement ensures the opening of the intermediate transfer unit to be restricted to the position immediately before collision with the main body of the apparatus.

In the color image forming apparatus of item 17, the opening regulation member is rotated by the first link mechanism of the interlocking section based on the opening angle of the intermediate transfer unit. When the intermediate transfer unit opens, this arrangement ensures the opening of the intermediate transfer unit to be restricted to the position immediately before collision with the main body of the apparatus.

In the color image forming apparatus of item 18, the opening regulation member is moved to the unit interference limit position by the second link mechanism of the interlocking section. When the intermediate transfer unit opens, this arrangement ensures the opening of the intermediate transfer unit to be restricted to the position immediately before collision with the main body of the apparatus.

### BRIEF DESCRIPTION OF THE DRAWINGS

FIG. 1 is a conceptual diagram representing a configuration example of the color printer 100 in an embodiment of the present invention;

FIG. 2 is a perspective view showing an example of opening and closing an intermediate transfer unit 70 in a first Example;

FIG. 3 is a cross sectional view showing a configuration example of a rotary hinge section 60;

FIG. 4 is a top view showing a play setting example in the rotary hinge section 60;

FIG. 5 is a cross sectional view showing an example of mounting a composite unit 201;

FIG. 6 is a front view showing an example (No. 1) of handling the composite unit 201;

FIG. 7 is a cross sectional view showing an example (No. 2) of handling the composite unit 201;

FIG. 8 is a cross sectional view showing an example (No. 3) of handling the composite unit 201;

FIG. 9 is a perspective view showing an example (No. 4) of handling the composite unit 201;

FIG. 10 is a perspective view showing an arrangement example of a temporary fixing mechanism 20 in a second Example;

FIG. 11 is a front view showing a configuration example of the temporary fixing mechanism 20;

FIGS. 12A and 12B are cross sectional views showing an operation example of the temporary fixing mechanism 20;

FIGS. 13A and 13B are cross sectional views representing the configuration of a stopper link mechanism 30 in a third Example;

FIG. 14 is a cross sectional view showing the configuration example of the rotary hinge section 603;

FIG. 15 is a top cross sectional view showing an operation example (No. 1) of the stopper link mechanism 30;

FIG. 16 is a top cross sectional view showing an operation example (No. 2) of the stopper link mechanism 30;

FIG. 17 is a top cross sectional view showing an operation example (No. 3) of the stopper link mechanism 30;

FIGS. 18A and 18B are cross sectional views showing the configuration examples of a stopper link mechanism 40 in a fourth Example;

FIG. 19 is a cross sectional view showing the configuration example of a rotary hinge section 604;

FIG. 20 is a top cross sectional view showing the operation example (No. 1) of the stopper link mechanism 40;

FIG. 21 is a top cross sectional view showing the operation example (No. 2) of the stopper link mechanism 40;

FIG. 22 is a top cross sectional view showing the operation example (No. 3) of the stopper link mechanism 40; and

FIG. 23 is a perspective view representing an example of opening and closing the rack unit 95 of a color printer 500 in a fifth Example.

### DESCRIPTION OF THE PREFERRED EMBODIMENTS

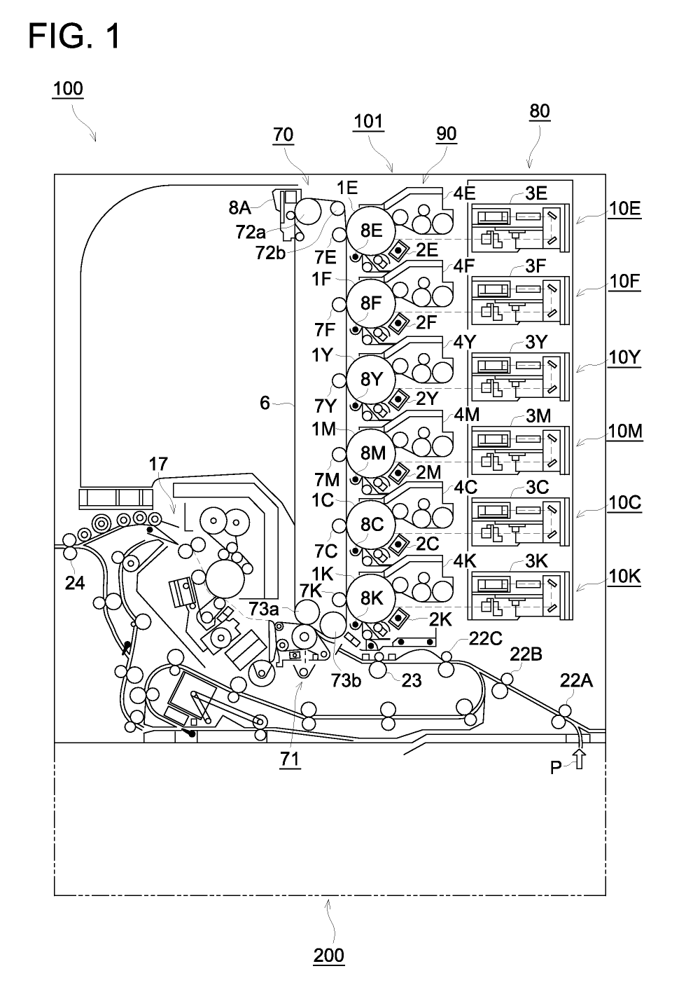

The following describes a color image forming apparatus in an embodiment of the present invention with reference to the drawings. The vertical tandem type color printer 100 of FIG. 1 is an example of the color image forming apparatus, and has a main body 101 for forming a color image. In the main body 101, image information is inputted and colors are superimposed on the intermediate transfer belt 6 (image carrier) based on the image information, so that a color image is formed. The image information is supplied to the color printer 100 from such an external device as a personal computer and is forwarded to the image forming section 80.

The image forming section 80 is mounted on the main body 101. The main body 101 includes an intermediate transfer unit 70 and image forming rack unit 90 that can be removed from or inserted into the main body 101. The intermediate transfer unit 70 is provided with an endless intermediate transfer belt 6.

The image forming section 80 forms a color toner image on the intermediate transfer belt 6 based on the image information. For example, the image forming section 80 includes an image forming unit 10Y having a yellow (Y) photoreceptor drum 1Y, an image forming unit 10M having a magenta (M) photoreceptor drum 1M, an image forming unit 10C having a cyan (C) photoreceptor drum 1C, and an image fanning unit 10K having a black (K) photoreceptor drum 1K. The image forming section 80 is further provided with two image forming units 10E and 10F for a special printing mode.

In the image forming section 80, an image is formed and processed for each of the photoreceptor drums 1E, 1F, 1Y, 1M, 1C and 1K. The toner images formed and processed by the photoreceptor drums 1E, 1F, 1Y, 1M, 1C and 1K of various colors are superimposed on the intermediate transfer belt 6, so that a full-color image is formed.

In this example, the image forming unit 10Y includes a charging device 2Y, image writing unit 3Y, development unit 4Y and cleaning section 8Y for image formation in addition to the photoreceptor drum 1Y, so that a yellow (Y) color image is formed. The photoreceptor drum 1Y is rotatably installed close to the upper right side of the intermediate transfer belt 6, for example, so that a Y-color color toner image is formed. In this example, the photoreceptor drum 1Y rotates in the counterclockwise direction. A charging device 2Y is installed obliquely to the lower right of the photoreceptor drum 1Y, and the surface of the photoreceptor drum 1Y is charged to a prescribed potential level.

Opposed thereto, an image writing unit 3Y is provided almost just beside the photoreceptor drum 1Y. The photoreceptor drum 1Y charged in advance is scanned by the laser beam having a prescribed intensity based on the Y-color image data and is exposed thereto. The image writing unit 3Y uses a polygon mirror type laser exposure scanning device. A Y-colored electrostatic latent image is formed on the photoreceptor drum 1Y.

A development unit 4Y is installed above the image writing unit 3Y, and develops the Y-colored electrostatic latent image formed on the photoreceptor drum 1Y. In the following description, the electrostatic latent image developed by toner particles will be referred to as a toner image. The Y-color toner image formed on this photoreceptor drum 1Y is transferred onto the intermediate transfer belt 6 by the operation of the primary transfer roller 7Y (primary transfer operation). The cleaning section 8Y is installed below the left of the photoreceptor drum 1Y, and cleans from the photoreceptor drum 1Y the toner particles remaining after the previous writing operation.

In this example, an image forming unit 10M is installed below the image forming unit 10Y. The image forming unit 10M includes a photoreceptor drum 1M, charging device 2M, image writing unit 3M, development unit 4M and cleaning section 8M for image formation, and forms a magenta (M) image. An image forming unit 10C is installed below the image forming unit 10M. The image forming unit 10C includes a photoreceptor drum 1C, charging device 2C, image writing unit 3C, development unit 4C and cleaning section 8C for image formation, and forms a cyan (C) image.

An image forming unit 10K is provided below the image forming unit 10C. The image forming unit 10K has a photoreceptor drum 1K, charging device 2K, image writing unit 3K, development unit 4K and cleaning section 8K for image formation, and forms a black (BK) image. OPC (Organic Photo Conductor) drums are used as the photoreceptor drums 1Y, 1M, 1C and 1K.

The functions of various members of the image forming units 10M through 10K will not be described, because the description of the functions of the members of the image forming unit 10Y is applicable to those of the members of other units having the same reference numerals by replacing Y with M, C or K.

Out of the six image forming units 10E, 10F, 10Y, 10M, 10C and 10K of the image forming section 80 mentioned above, six photoreceptor drums 1E, 1F, 1Y, 1M, 1C and 1K, six charging devices 2E, 2F, 2Y, 2M, 2C and 2K, six development units 4E, 4F, 4Y, 4M, 4C and 4K, and six cleaning sections 8E, 8F, 8Y, 8M, 8C and 8K for image formation, except for six image writing units 3E, 3F, 3Y, 3M, 3C and 3K, are mounted on the rack unit 90.

In this example, to perform operations in the special printing mode, the image forming unit 10E has a photoreceptor drum 1E, charging device 2E, image writing unit 3E, development unit 4E and cleaning section 8E for image formation, so that a first special color image is formed. The image forming unit 10F has a photoreceptor drum 1F, charging device 2F, image writing unit 3F, development unit 4F and cleaning section 8F for image formation, so that a second special-color image is formed.

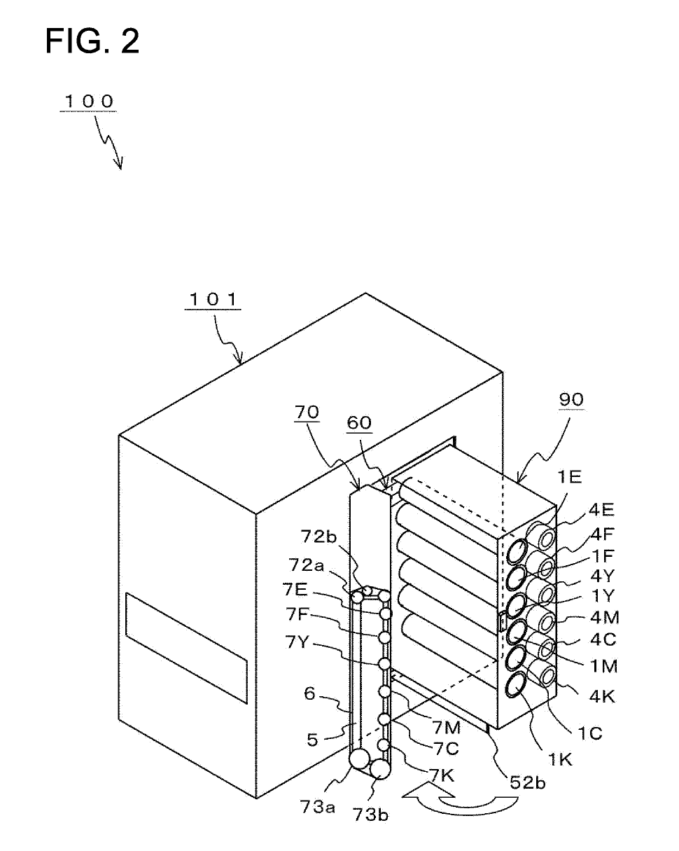

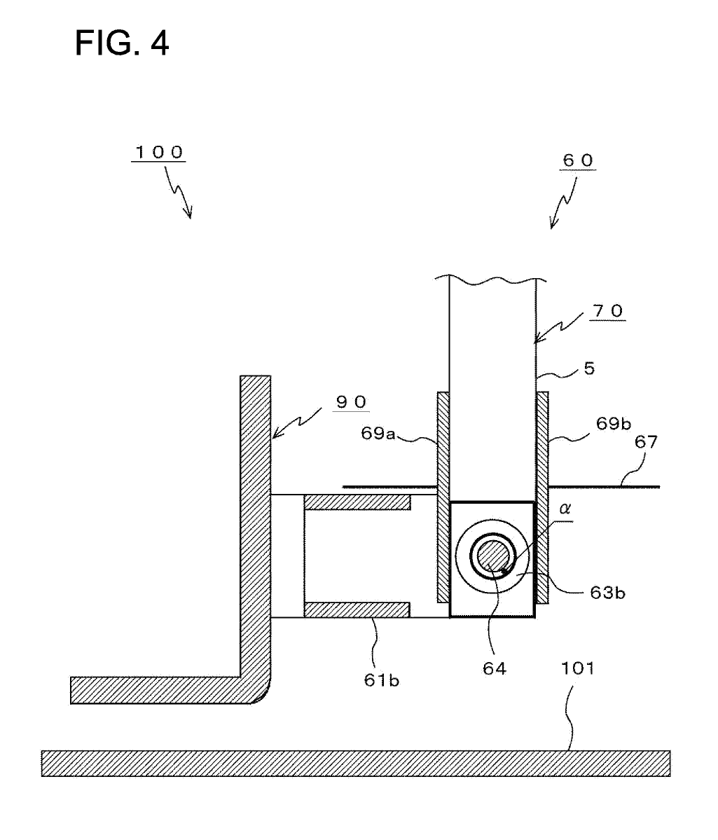

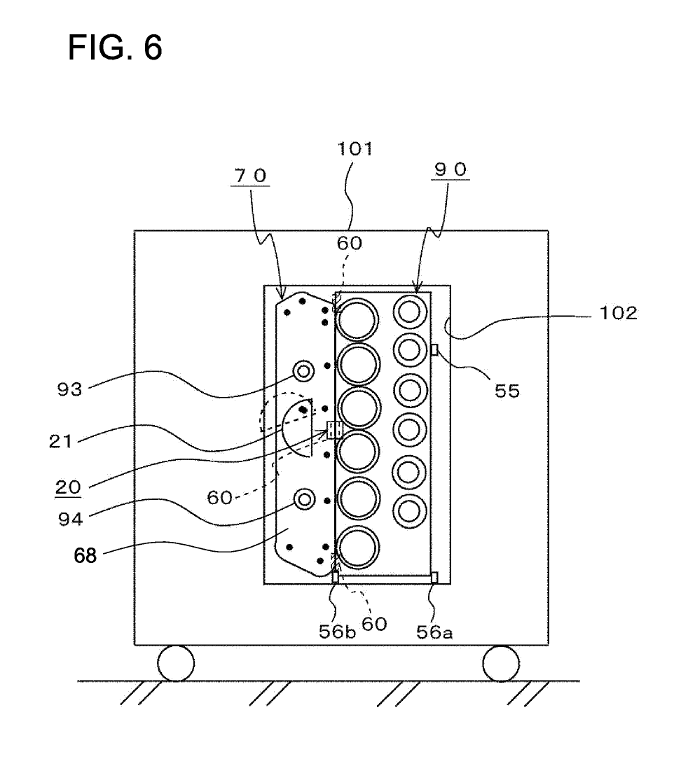

The intermediate transfer unit 70 transfers the color image formed by the rack unit 90 on which six photoreceptor drums, six charging devices, six development units and six cleaning sections are mounted. The intermediate transfer unit 70 includes a frame member 5 (FIG. 2), primary transfer rollers 7E, 7F, 7Y, 7M, 7C and 7K, top conveyance roller 72a, tension roller 72b, and bottom conveyance rollers 73a and 73b, in addition to the intermediate transfer belt 6. In addition, the intermediate transfer unit 70 is also provided with a rear panel of the intermediate transfer belt (hereinafter referred to as “intermediate transfer rear panel 67”, see FIG. 4) and a front panel of the intermediate transfer belt (hereinafter referred to as “intermediate panel front panel 68”, see FIG. 6).

The frame member 5, for example, has a rectangular shape. Primary transfer rollers 7E, 7F, 7Y, 7M, 7C and 7K, top conveyance rollers 72a and 72b, tension roller 72c, and bottom conveyance rollers 73a and 73b are mounted at prescribed positions of the frame member 5. The intermediate transfer belt 6 is endlessly mounted at such a position as to contain the top conveyance rollers 72a and 72b, tension roller 72c, and lower conveyance rollers 73a and 73b.

The intermediate transfer belt 6 superimposes the toner images transferred by the primary transfer rollers 7E, 7F, 7Y, 7M, 7C and 7K, and transfers the color toner image (color image). The color image formed on the intermediate transfer belt 6 is conveyed to the secondary transfer section 71 when the intermediate transfer belt 6 turns in the clockwise direction.

A secondary transfer section 71 is arranged below the intermediate transfer belt 6. The secondary transfer section 71 is pressed against the intermediate transfer belt 6, and the color image based on the toner image on the intermediate transfer belt 6 is transferred to the material to which the image is to be transferred (hereinafter referred to as “sheet P”). In this example, a cleaning section 8A is mounted on the upper left of the intermediate transfer belt 6 to clean the toner particles from the intermediate transfer belt 6 remaining after secondary transfer.

The color printer 100 includes a fixing device 17 and sheet supply section 200 in addition to the image forming section 80. The sheet supply section 200 is located below the aforementioned image forming unit 10K, and incorporates a plurality of sheet feed trays (not illustrated). Sheets P of a prescribed size are accommodated in each of the sheet feed trays. The sheet supply section 200 feeds out a prescribed sheet P to the secondary transfer section 71.

For example, conveyance rollers 22A through 22C, registration roller 23 and others are installed along the sheet conveyance path leading from the sheet supply section 200 to the position below the image forming unit 10K. The registration roller 23 ensures that a prescribed sheet P fed out of the sheet supply section 200 through the conveyance rollers 22A through 22C is held just before the secondary transfer section 71, and is fed out to the secondary transfer section 71 at a predetermined time interval. Without being restricted to the sheet feed tray installed below the image forming unit 10K, the sheet supply section 200 can be provided with the large-sized sheet feed device (not illustrated) on the external right of the color printer 100, so that the sheet P is fed by the combined use of this large-sized sheet feed device.

The secondary transfer section 71 transfers the color image carried on the intermediate transfer belt 6 onto a prescribed sheet P sent by the registration roller 23 under the control of sheet conveyance. A fixing device 17 is mounted downstream of the secondary transfer section 71, so that the sheet P with the color image transferred thereon is subjected to the fixing process. The sheet P subjected to the fixing process is sandwiched between the sheet ejection rollers 24, and is ejected to the sheet ejection tray (not illustrated) outside the machine.

### EXAMPLE 1

Referring to FIG. 2, the following describes an example of opening and closing the intermediate transfer unit 70 in a first Example. In this Example, the intermediate transfer unit 70 can be removed or inserted together with the rack unit 90, and can be opened or closed with respect to the rack unit 90 in the horizontal direction like a door.

When the main body 101 is viewed from the front adjacent to the rack unit 90, the intermediate transfer unit 70 of FIG. 2 is located at the center. The intermediate transfer unit 70 is mounted in such a way as to be opened or closed freely like a door in the horizontal direction through the rotary hinge section 60 provided on the furthest side of the rack unit 90. The rotary hinge section 60 constitutes a rotary fulcrum of the intermediate transfer unit 70 and rack unit 90 on the furthest side of the intermediate transfer unit 70. It goes without saying that the rotary fulcrum can be set on the front of the rack unit 90, instead of the nearest side of the rack unit 90.

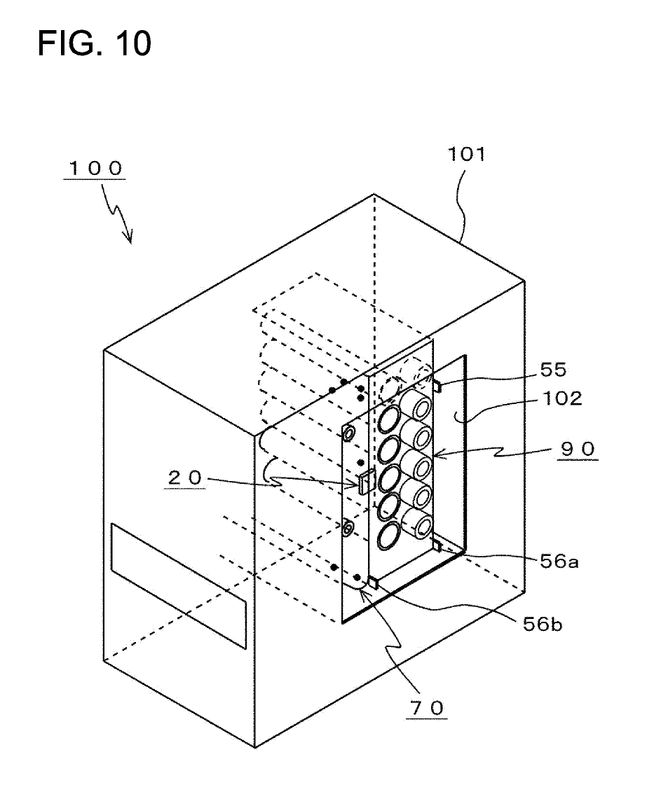

In this example, the intermediate transfer unit 70 can be removed or inserted into the main body 101 from the outside (nearest side) by the temporary fixing mechanism 20 (the second Example) of FIG. 10 with the intermediate transfer unit 70 and rack unit 90 being clamped on a temporary basis (one set). After the intermediate transfer unit 70 has been pulled out of the main body 101 to the outside (nearest side), if the intermediate transfer unit 70 is pulled out of the rack unit 90 by a force greater than the biasing force provided by the temporary fixing mechanism 20, the intermediate transfer unit 70 can be opened or closed freely like a door in the horizontal direction through the rotary hinge section 60 provided on the furthest side of the rack unit 90.

According to the color printer 100, this printer is provided with the image forming rack unit 90 that, together the intermediate transfer unit 70, can be removed from or inserted into the main body 101. This allows the intermediate transfer unit 70 to be opened or closed freely like a door in the horizontal direction with respect to the rack unit 90, with the rack unit 90 pulled out of the main body 101.

The intermediate transfer unit 70 is mounted in such a way as to be opened or closed freely like a door in the horizontal direction through the rotary hinge section 60 provided on the furthest side of the rack unit 90. This structure ensures the intermediate transfer belt 6 and others to be replaced without the intermediate transfer unit 70 being dismounted from the main body 101.

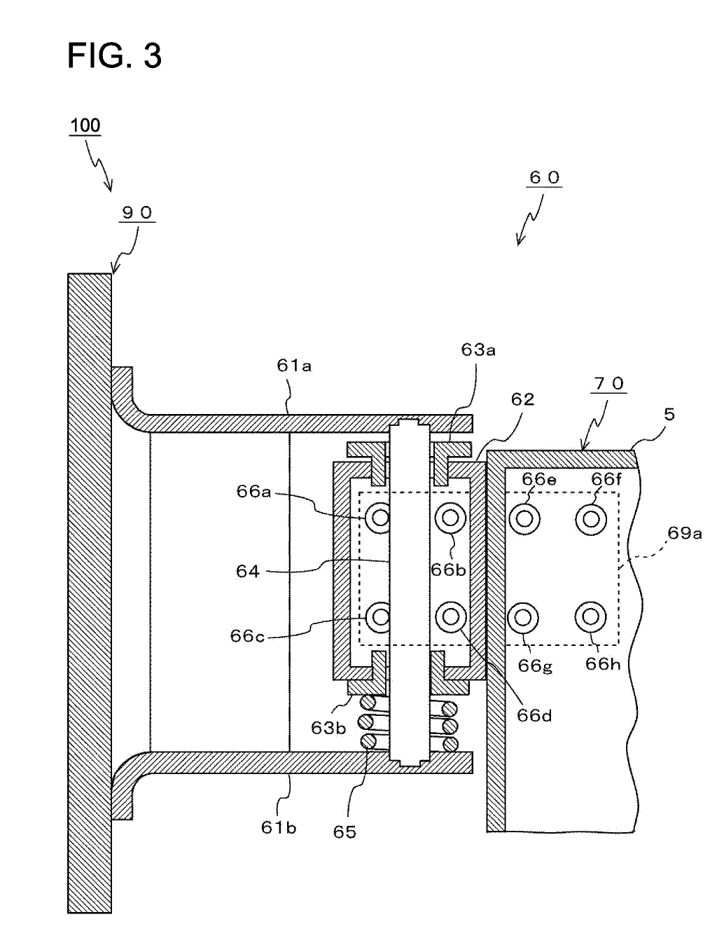

Referring to FIG. 3, the following describes a configurational example of a rotary hinge section 60. The rotary hinge section 60 of FIG. 3 is installed on the furthest side of the rack unit 90. A total of two or more rotary hinge sections 60 are installed. These rotary hinge sections 60 are installed in the upper and lower portions on the furthest side of the rack unit 90, preferably still in the middle stage on the furthest side. Installation of a plurality of rotary hinge sections 60 is intended to support on the one side wherein the unit is hung, the intermediate transfer unit 70 ever increasing in size and weight. The reference numeral 67 in the drawing represents an intermediate transfer rear panel.

The rotary hinge section 60 includes fulcrum support plates 61a and 61b, bearing support member 62, bearing sections 63a and 63b, rotary fulcrum shaft 64, and positioning gap absorbing oscillating spring 65. The oscillating spring 65 constitutes an example of the damper member. A biasing member such as a sprig coil is used as the oscillating spring 65. When a stress is applied to the intermediate transfer unit 70 from the above, the oscillating spring 65 rocks so as to expand and contract in the vertical direction of the rotary hinge section 60, thereby absorbing the gap at the time of positioning.

Each of the fulcrum support plates 61a and 61b and bearing support member 62 are formed by cutting, punching and bending sheet metal having a prescribed thickness. The fulcrum support plates 61a and 61b have a prescribed shape and are installed on the furthest side of the rack unit 90. For example, the fulcrum support plates 61a and 61b are fixed on the rack unit 90 by means of welding or bolts and nuts.

The bearing support member 62 has a box-shaped structure and is provided with shaft holes (prepared holes, not illustrated) on the top and bottom. The shaft hole on the top of the bearing support member 62 is provided with a bearing section 63a. The shaft hole on the bottom of the bearing support member 62 is provided with a bearing section 63b. Bearings and others are used in the bearing sections 63a and 63b.

The rotary fulcrum shaft 64 has a prescribed external diameter. After the rotary fulcrum shaft 64 has been passed through the bearing section 63a on the top of the bearing support member 62 and the bearing section 63b on the bottom of the bearing support member 62, an oscillating spring 65 is inserted into the bottom of the bearing support member 62. The rotary fulcrum shaft 64 is installed in such a way as to be sandwiched between the fulcrum support plates 61a and 61b. The rotary fulcrum shaft 64 is not designed to rotate. The oscillating spring 65 is mounted on the rotary hinge section 60 (not illustrated) on the lower position of the rotary hinge section 60 in the upper position, and also on the rotary hinge section 60 of the middle-stage position.

The bearing support member 62 and intermediate transfer unit 70 are connected through a set of connection plates 69a and 69b having a prescribed thickness. The drawing shows only the connection plate 69a. For example, the bearing support member 62 and connection plates 69a and 69b are rigidly fixed by four engaging members 66a through 66d in such a way that the bearing support member 62 is sandwiched between the connection plates 69a and 69b on one side. In this case, the engaging members 66a through 66d are arranged to penetrate the bearing support member 62 in such a direction as to be parallel with the rotation shaft fulcrum of the rotary fulcrum shaft 64.

The connection plates 69a and 69b and intermediate transfer unit 70 are rigidly fixed in position by four engaging member 66e through 66h in such a way that the frame member 5 of the intermediate transfer unit 70, for example, is sandwiched between the connection plates 69a and 69b on the other side. For example, bolts and nuts are used as the engaging members 66a through 66h. This arrangement constitutes the rotary hinge section 60 that is suspended at one position.

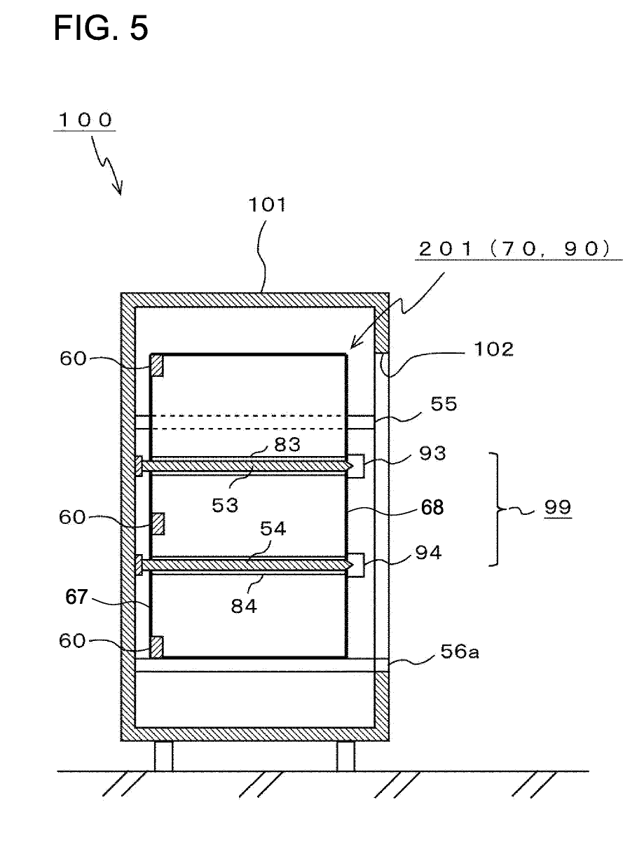

A similar arrangement is adopted for the rotary hinge section 60 of another suspension method, and the description thereof will be omitted to avoid duplication. The aforementioned oscillating spring 65 is designed to support the mounting load received by the penetration shaft as shown in FIG. 5. This structure ensures easy installation of the composite unit made up of an intermediate transfer unit 70, a rack unit 90 (hereinafter referred to as “composite unit 201”) and reduced wear of the bearing sections 63a and 63b.

Referring to FIG. 4, the following describes an example of setting the play in the rotary hinge section 60. In the color printer 100 of FIG. 4, a misregistration gap adjusting play a (clearance) is set around the rotary fulcrum shaft 64 of the rotary hinge section 60. The play a is a gap formed between the rotary fulcrum shaft 64 and bearing sections 63a and 63b. If play a is set around the rotary fulcrum shaft 64 of the rotary hinge section 60, the vertical movement of the intermediate transfer unit 70 is absorbed by the oscillating spring 65, so that allowance is provided in the longitudinal and lateral directions. If misregistration gap adjusting play a is provided around the rotary fulcrum shaft 64 of the rotary hinge section 60, high-precision positioning of the intermediate transfer unit 70 is provided by the penetration shaft 53, 54 of FIG. 5.

The following describes an example of mounting the composite unit 201 with reference to FIG. 5. In this example, the intermediate transfer unit 70 and rack unit 90 constitute the composite unit 201 wherein both the pull-out operation and mounting operation are performed integrally.

The color printer 100 of FIG. 5 has a positioning mechanism 99. The positioning mechanism 99 includes a plurality of penetration shafts 53 and 54 for positioning, through-holes 83 and 84, and unit mold clamping fixtures 93 and 94. The main body 101 has a rear panel 107 and front panel 108.

The penetration shafts 53 and 54 are installed at a prescribed position of the rear panel 107. For example, one end of each of the penetration shafts 53 and 54 is fixed at a prescribed position of the rear panel 107 by welding and other means. The other end of each of the penetration shafts 53 and 54 has a sharp conical edge to ensure easy pulling of the through-holes 83 and 84 toward the inside.

In the meantime, the intermediate transfer unit 70 has an intermediate transfer front panel 68 (the front panel) and intermediate transfer rear panel 67. A prescribed position of the intermediate transfer front panel 68 is provided with a positioning opening (not illustrated) that allows exposure of the tips of the penetration shafts 53 and 54. This opening constitutes an example of the bearing section and a female screw is formed inside the opening for the bearing section.

Between the intermediate transfer rear panel 67 and intermediate transfer front panel 68 wherein the opening for the bearing section of the intermediate transfer front panel 68 and penetration shafts 53 and 54 are included, corresponding through-holes 83 and 84 are provided so as to crosslink both ends. The through-holes 83 and 84 use a pipe member (pipe) having a prescribed inner diameter capable of including each of the penetration shafts 53 and 54. One end of each of the through-holes 83 and 84 is attached to the intermediate transfer rear panel 67, and the other end of each of the through-holes 83 and 84 is attached to the intermediate transfer front panel 68.

When the composite unit 201 is mounted, the penetration shafts 53 and 54 penetrate the through-holes 83 and 84 corresponding to the penetration shafts 53 and 54 respectively, so that the tips thereof will be exposed from the opening for the bearing section of the intermediate transfer front panel 68. The penetration shafts 53 and 54 employ a metallic rod having a prescribed outer diameter.

The fixtures 93 and 94 constitute an example of the engaging member, and are formed, for example, of a cylindrical cylinder having a stepped upper plate and containing a convex cross section. One end of each of the fixtures 93 and 94 has a male screw that is matched with the female screw formed inside the opening for the bearing section of the intermediate transfer front panel 68. A hole position is provided internally around the male screw. This hole position is processed so as to allow insertion of the ends of the penetration shafts 53 and 54 having a sharp conical shape. Needless to say, it is also possible to adopt such a structure as to form a male screw on one end of each of the penetration shaft 53 and 54, and to mount the fixtures 93 and 94 having a female screw matching with this male screw. A positioning mechanism 99 is thereby formed.

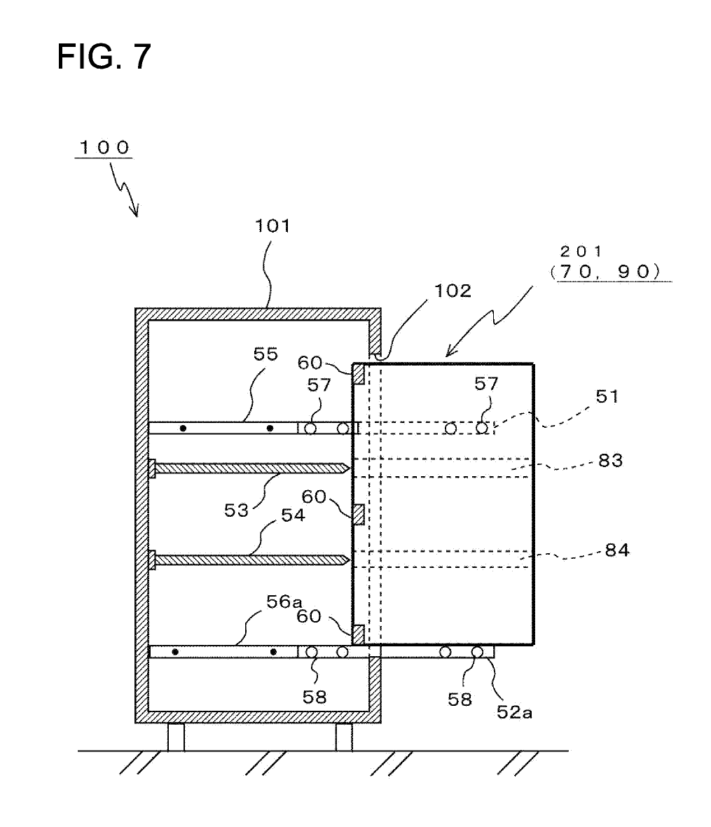

The rack unit 90 is mounted on the rail members 55, 56a and 56b installed at a prescribed position of the main body 101. The rail members 55, 56a and 56b employ elastic slide rails. In this example, the rack unit 90 is slidably supported by three rail members 55, 56a and 56b (FIG. 6). The rail members 55, 56a and 56b are installed at a prescribed position of the internal frame (not illustrated) of the main body 101. The rack unit 90 has rail members 51, 52a and 52b and roller members 57 and 58 (FIG. 7).

The rail member 51 is slidably mounted on the rail member 55 through the roller member 57. The rail member 52a is slidably assembled with the rail member 56a through the roller member 58. The rail member 52b is slidably assembled with the rail member 56b through the roller member 58, although this is not illustrated. The color printer 100 is formed by this arrangement. The reference numeral 20 in the drawing represents a temporary fixing mechanism, and 21 denotes an opening regulation member. The temporary fixing mechanism 20 will be described with reference to the second Example. The opening regulation member 21 will be described with reference to the third and the fourth Examples.

According to the color printer 100, the composite unit 201 consisting of an intermediate transfer unit 70 and rack unit 90 is automatically adjusted to the main body 101 in a self-alignment structure. Moreover, this structure eliminates the need of mounting or removing the front panel 97 of the main body 101 as a reference for positioning so that the positioning stability is enhanced.

Referring to FIGS. 6 through 9, the following describes an example of handling the composite units 201 (Nos. 1 through 3) in a first Example. In this example, the intermediate transfer unit 70 is installed so as to be opened or closed like a door in the horizontal direction with respect to the rack unit 90 through the rotary hinge section 60 installed on the furthest side of the rack unit 90. The composite unit 201 is pulled out of the main body 101 and the intermediate transfer belt 6 of the intermediate transfer unit 70 is replaced.

The unit mold clamping fixtures 93 and 94 on the intermediate transfer front panel 68 of FIG. 6 are loosened, and the fixtures 93 and 94 are removed from the opening for the bearing section of the relevant intermediate transfer front panel 68. When the fixtures 93 and 94 have been removed from the opening of the bearing section, the tips of the penetration shafts 53 and 54 are exposed to the outside.

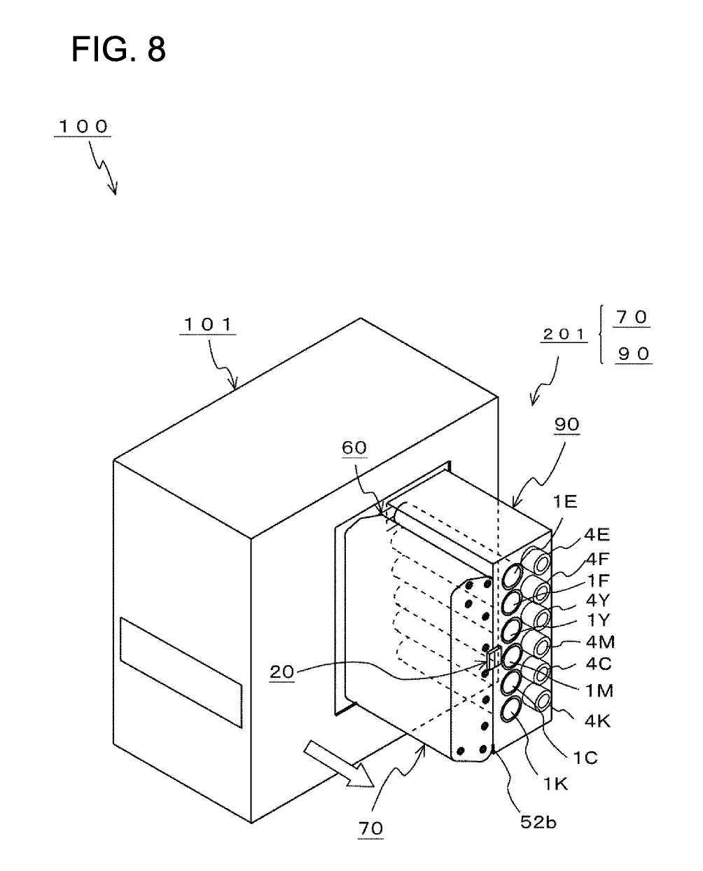

When the tips of the penetration shafts 53 and 54 are exposed to the outside as shown in FIG. 6, the composite unit 201 is pulled out of the main body 101, as shown in FIG. 7. In this case, when the rack unit 90 supported slidably by the rail members 51, 52a and 52b and roller members 57 and 58 on the three rail members 55, 56a and 56b is pulled outside, the intermediate transfer unit 70 is also pulled out integrally therewith (FIG. 8).

In this example, as shown in FIG. 7, when the penetration shafts 53 and 54 have been pulled out of the through-holes 83 and 84 respectively, the opening and closing operation of the intermediate transfer unit 70 is enabled. Preferably, the composite unit 201 is pulled out in the direction indicated by the write-out mark of FIG. 8. When the composite unit 201 has been sufficiently pulled out from the main body 101, the opening operation of the intermediate transfer unit 70 is preferably started.

This is intended to avoid the operation of opening from the rack unit 90 with the rotary hinge section 60 used as a reference, to the intermediate transfer unit 70, when the penetration shafts 53 and 54 have been inserted into the through-holes 83 and 84. The intermediate transfer unit 70 is temporarily retained on the rack unit 90 by a temporary retaining mechanism 20 at the time of the pull-out operation and after completion of the pull-out operation.

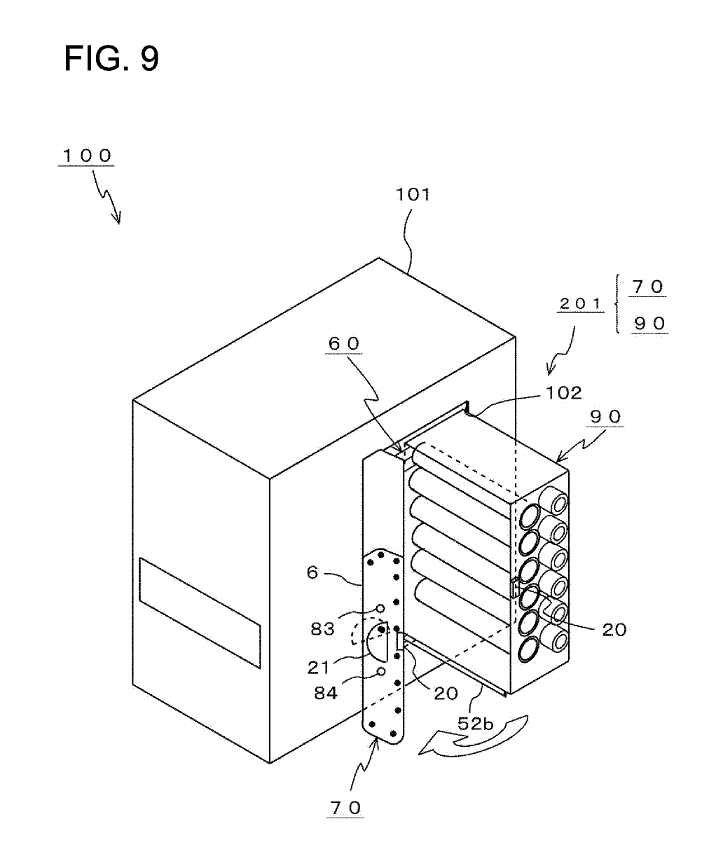

This is followed by the step of opening the intermediate transfer unit 70 with respect to the rack unit 90 of FIG. 9. In this case, a grip (not illustrated) installed at a prescribed position of the intermediate transfer unit 70 is held by the user to open the intermediate transfer unit 70 in the direction indicated by the white-out arrow mark, namely, toward the left.

In this case, external force is applied, which is greater than the coercive force of the magnet member by the temporary fixing mechanism 20. In the rack unit 90, the intermediate transfer unit 70 opens like a door in the horizontal direction with respect to the rotary hinge section 60, and the intermediate transfer unit 70 is opened from the rack unit 90. This allows the intermediate transfer belt 6 to be replaced with the intermediate transfer unit 70 kept open.

As described above, according to the color printer 100 in the first Example, an intermediate transfer unit 70 provided thereon can be removed from and inserted into the main body 101, and can be opened or closed in the horizontal direction like a door. The intermediate transfer unit 70 can be opened or closed like a door in the horizontal direction with respect to the rack unit 90 through the rotary hinge section 60 installed on the furthest side of the rack unit 90.

This door-like open/close structure allows the intermediate transfer unit 70 to be opened or closed like a door, with the intermediate transfer unit 70 kept pulled out of the main body 101 at the time of belt replacement, and permits the intermediate transfer belt 6 to be replaced, without having to dismount the intermediate transfer unit 70 from the main body 101 that may be difficult to remove due to an increase in the size of the color printer 100. Further, an operator in the standing position is allowed to overlook the entire unit and to have easy access to both sides, front and back side of the unit to perform manual maintenance work. This signifies a drastic improvement in the maintainability.

According to the first Example, the positioning mechanism 99 provided thereon eliminates the need of mounting or removing the front panel 97 as a reference for positioning so that the positioning stability is enhanced. Play α is assigned in the vertical and horizontal directions of the rotary hinge section 60 to ensure high-precision positioning by the penetration shafts 53 and 54. Moreover, the aforementioned oscillating spring 65 is designed to support the mounting load received by the penetration shafts 53 and 54 when the composite unit 201 is mounted. This structure ensures easy installation of the composite unit, a rack unit 90 and reduced wear of the bearing sections 63a and 63b.

In the description of the color printer 100 of the first Example, the intermediate transfer unit 70 is installed so as to be opened or closed in the horizontal direction like a door with respect to the rack unit 90, through the rotary hinge section 60 installed on the furthest side of the rack unit 90. However, the present invention is not restricted to this description.

For example, the following structure can be designed. A rotary hinge section 60 is installed on the nearest side of the rack unit 90, and this rotary hinge section 60 is provided with an intermediate transfer unit 70 to ensure that the intermediate transfer unit 70 can be opened or closed in the horizontal direction like a door with respect to the rack unit 90. This structure also permits the intermediate transfer belt 6 to be replaced, without having to dismount the intermediate transfer unit 70 from the main body 101.

### EXAMPLE 2

Referring to FIG. 10 through FIG. 12, the following describes the temporary fixing mechanism 20 in the color printer 100 of the second Example. In the color printer 100 of FIG. 10, the intermediate transfer unit 70, together with the rack unit 90, can be removed from or inserted into the main body 101. Further, the color printer 100 is capable of opening or closing in the horizontal direction like a door. A temporary fixing mechanism 20 is installed between the rack unit 90 and intermediate transfer unit 70.

The temporary fixing mechanism 20 is located almost at the center of the composite unit 201 wherein the intermediate transfer unit 70 is closed with respect to the rack unit 90, for example. In this example, the temporary retaining mechanism 20 is arranged on the boundary line formed by one end of the intermediate transfer front panel 68 and one end of the front panel 98 when the intermediate transfer unit 70 is closed with respect to the rack unit 90.

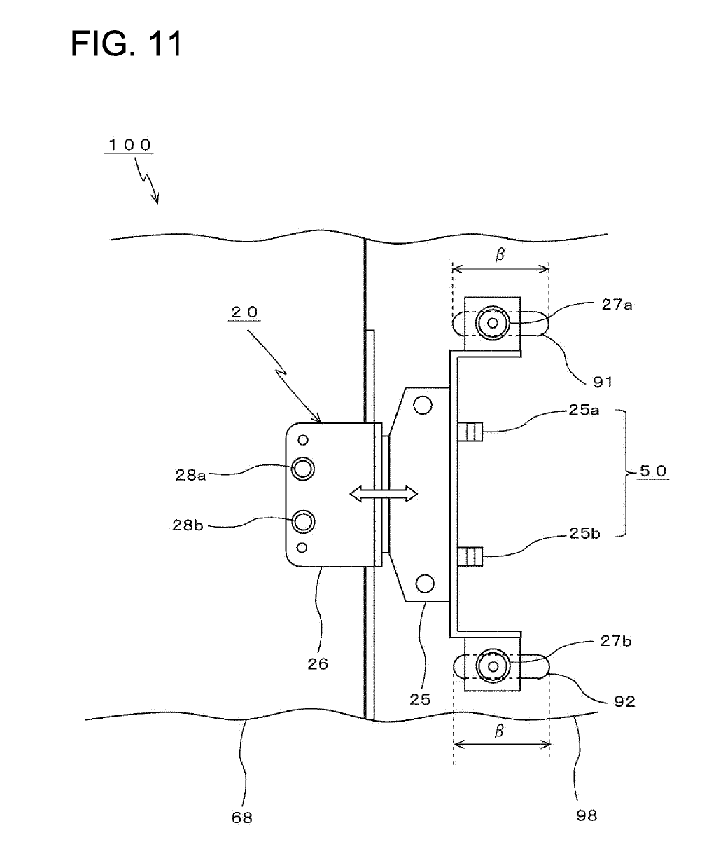

Referring to FIG. 11, the following describes an example of configuring the temporary fixing mechanism 20. The temporary retaining mechanism 20 of FIG. 11 includes a magnet 25, sucked plate 26 and installation support base 205.

The magnet 25 forms an example of the magnetic member, and is installed on the installation support base 205 through position adjusting screws 29a and 29b so that misregistration can be absorbed. The magnet 25 can be made of any material; it may have a prescribed magnetic force. The installation support base 205 has a prescribed shape and is installed on the front panel 98 of the rack unit 90 so that the position can be adjusted as desired. The installation support base 205 is formed by cutting, boring and bending a sheet metal member.

In this example, the installation support base 205 is installed with respect to the slots 91 and 92 formed on the front panel 98, using screw members 27a and 27b for fixing in position, so that the installation support base 205 can be moved in the lateral direction (back/forth direction) relative to the unit attracting direction. The unit attracting direction in the sense in which it is used here refers to the direction wherein the intermediate transfer unit 70 is sucked with reference to the rack unit 90.

The slots 91 and 92 have a misregistration gap adjusting play β (play) with respect to the screw members 27a and 27b. The play β is equivalent to the length of the slots 91 and 92 in the longitudinal direction, and is set at several times the outer diameter dimension of the screw members 27a and 27b. The play β is set in the unit attracting direction. When the misregistration gap is absorbed, the installation support base 205 provided with a magnet 25 moves the amount of misregistration.

In the meantime, the sucked plate 26 has an L-shaped cross sectional view, and is mounted on the intermediate transfer front panel 68 of the intermediate transfer unit 70. The sucked plate 26 is set on the intermediate transfer front panel 68 using two fixing screws 28a and 28b at a position, for example, opposed to the magnet 25 and close to the boundary formed by one end of the intermediate transfer front panel 68 and that of the front panel 98 of the rack unit 90. The temporary fixing mechanism 20 is formed by these components.

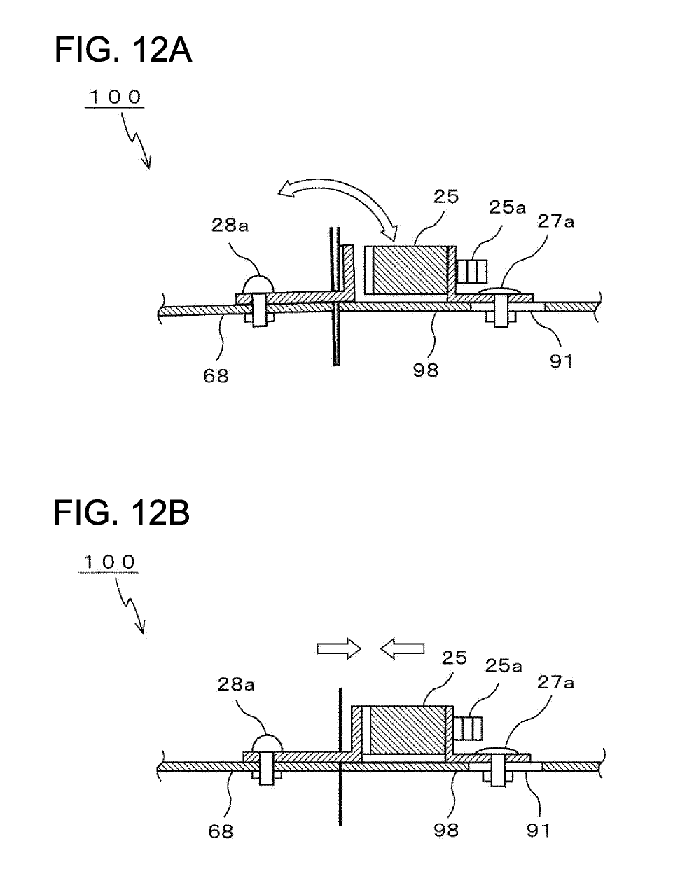

Referring to FIGS. 12A and 12B, the following describes an example of the operation of the temporary fixing mechanism 20. In this example, when the unit is accommodated in position, the intermediate transfer unit 70 can be temporarily set on the rack unit 90 by the temporary fixing mechanism 20 before the composite unit 201 is fixed onto the main body 101 by the fixtures 93 and 94.

In the color printer 100 of FIG. 12A, closing operation started from the opened position of the intermediate transfer unit 70 shown in FIG. 9, and the intermediate transfer unit 70 has come very close to being closed completely. Under this condition, the sucked plate 26 is sucked by the magnet 25. In the temporary fixing mechanism 20 of FIG. 12B, the magnet 25 adheres to the sucked plate 26. In this case, the intermediate transfer unit 70 is kept temporarily set to the rack unit 90.

Under this condition, in the intermediate transfer unit 70 of FIG. 7, the through-hole 83 is inserted into the penetration shaft 53, and the through-hole 84 is inserted into the penetration shaft 54. Further, when the composite unit 201 being sucked is pushed into the furthest side of the main body 101, this position is loaded as shown in FIG. 5 and FIG. 6. The tips of each of the penetration shafts 53 and 54 are kept exposed to the opening for the bearing section corresponding to the intermediate transfer front panel 68.

After that, the fixtures 93 and 94 are mounted at the opening for the bearing section of the intermediate transfer front panel 68, and the unit die clamping operation is performed. In this case, the sharp conical tips of the penetration shafts 53 and 54 are inserted into the holes of the fixtures 93 and 94, and automatic centering (positioning) operation is performed. Further, the magnet 25 performs self-aligning movement in such a way that the temporary retaining mechanism 20 absorbs the misregistration gap in the unit attracting direction. This arrangement allows the composite unit 201 to be loaded onto the main body 101.

As described above, the color printer 100 of the second Example is provided with an intermediate transfer unit 70 which, together the rack unit 90, is removed from or inserted into the main body 101 and which can be opened or closed like a door in the horizontal direction. A temporary fixing mechanism 20 is provided between this rack unit 90 and intermediate transfer unit 70. This temporary fixing mechanism 20 has a misregistration gap adjusting play β.

When the composite unit 201 consisting of the intermediate transfer unit 70 and rack unit 90 is mounted on the main body 101, a rough guide is provided by this misregistration gap adjusting play structure, thereby avoiding interference between the intermediate transfer belt 6 and photoreceptor drums 1E, 1F, 1Y, 1M, 1C and 1K or interface between the main body 101 and intermediate transfer unit 70.

### EXAMPLE 3

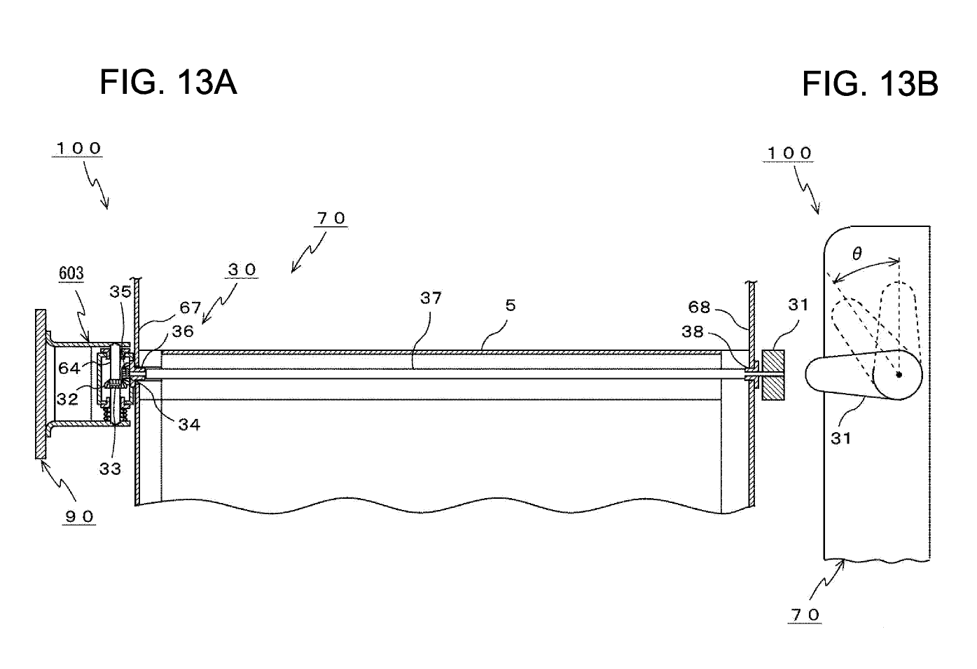

Referring to FIGS. 13 through 17, the following describes the stopper link mechanism 30 of a color printer 100 in the third Example. In this Example, the pressure member 31 is rotated by the torque of the rotary hinge section 603 when the intermediate transfer unit 70 explained with reference to the first and the second Examples is opened. Thus, the pressure member 31 is protruded from the position that interferes with the main body 101 and contains the intermediate transfer belt 6.

The color printer 100 of FIG. 13A includes a pressure member 31 and a stopper link mechanism 30 constituting an example of the first link mechanism, in addition to the intermediate transfer unit 70 explained with reference to the first and second Examples. The stopper link mechanism 30 has rotary transmission gears 32 and 34, gear fixing pins 33 and 35, arm support shaft bearing sections 36 and 38 and arm support shaft 37 (rotary shaft), whereby an interlocking section is formed.

The pressure member 31 constitutes an example of the opening regulation member 21 of FIG. 9, and regulates the degree of opening of the relevant intermediate transfer unit 70. For example, the pressure member 31 protrudes from the position which interferes with the main body 101 when the relevant intermediate transfer unit 70 is opened with respect to the main body 101 described with reference to the first and second Examples and which contains the intermediate transfer belt 6.

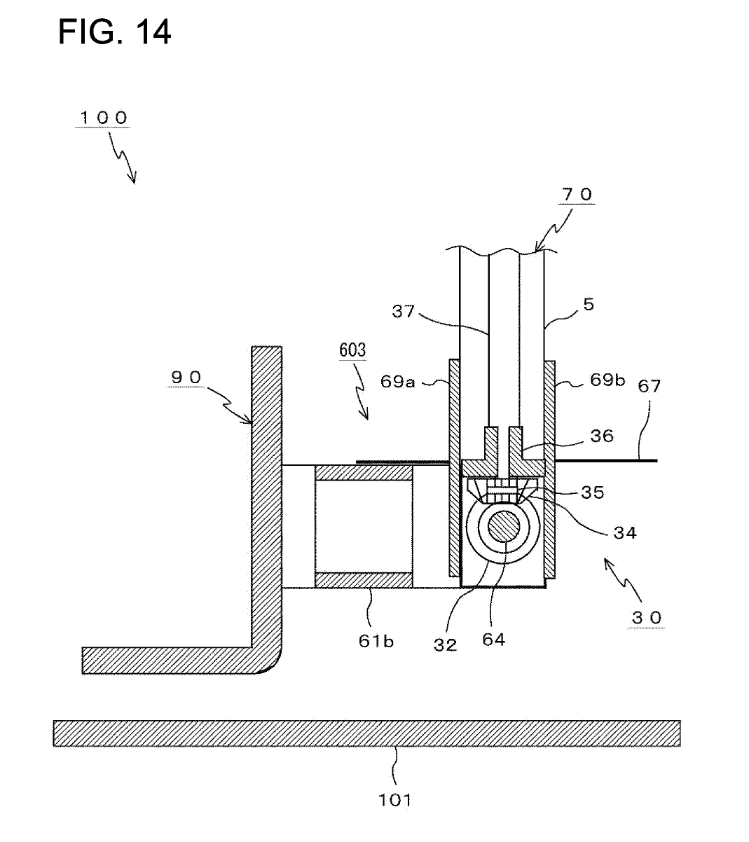

The rotary hinge section 603 of FIG. 14 constitutes an interlocking section and is interlocked with the opening operation of the intermediate transfer unit 70 to allow the pressure member 31 to protrude. The rotary fulcrum shaft 64 of the rotary hinge section 603 is provided with a rotary transmission gear 32. The rotary transmission gear 32 has a shaft hole (not illustrated). The rotary fulcrum shaft 64 is inserted into this shaft hole and is fixed onto the rotary fulcrum shaft 64 by means of a gear fixing pin 33.

An arm support shaft bearing section 36 is mounted on the side of the bearing support member 62 perpendicular to the rotary fulcrum shaft 64 in the rotary hinge section 603. In the arm support shaft bearing section 36, one end of the arm support shaft 37 (rotary shaft) is rotatably supported. One end of this arm support shaft 37 is equipped with a rotary transmission gear 34. The arm support shaft bearing section 36 is mounted from the side of the bearing support member 62 in such a way as to extend toward the intermediate transfer rear panel 67.

Spiral gears are used as rotary transmission gears 32 and 34. The rotary transmission gears 32 and 34 have a one-to-one gear ratio. The rotary shaft direction of the rotary fulcrum shaft 64 is changed to the perpendicular direction without the gear ratio of the rotary transmission gears 32 and 34. A spiral gear is used as a rotary transmission gear 34. The rotary transmission gear 34 has a shaft hole (not illustrated). One end of the arm support shaft 37 is inserted into this shaft hole, and is fixed onto the arm support shaft 37 by means of a gear fixing pin 35.

In the meantime, the other end of the arm support shaft 37 penetrates the intermediate transfer front panel 68, as shown in FIG. 13. An opening (not illustrated) is formed on the portion of the intermediate transfer front panel 68 penetrated by the other end of this arm support shaft 37. An arm support shaft bearing section 38 is connected with this opening. In the arm support shaft bearing section 38, the other end of the arm support shaft 37 is rotatably supported. The other end of this arm support shaft 37 is provided with a pressure member 31 having a shape shown in FIG. 13B. These components constitute a stopper link mechanism 30, and the pressure member 31 is rotated by the torque of the rotary fulcrum shaft 64.

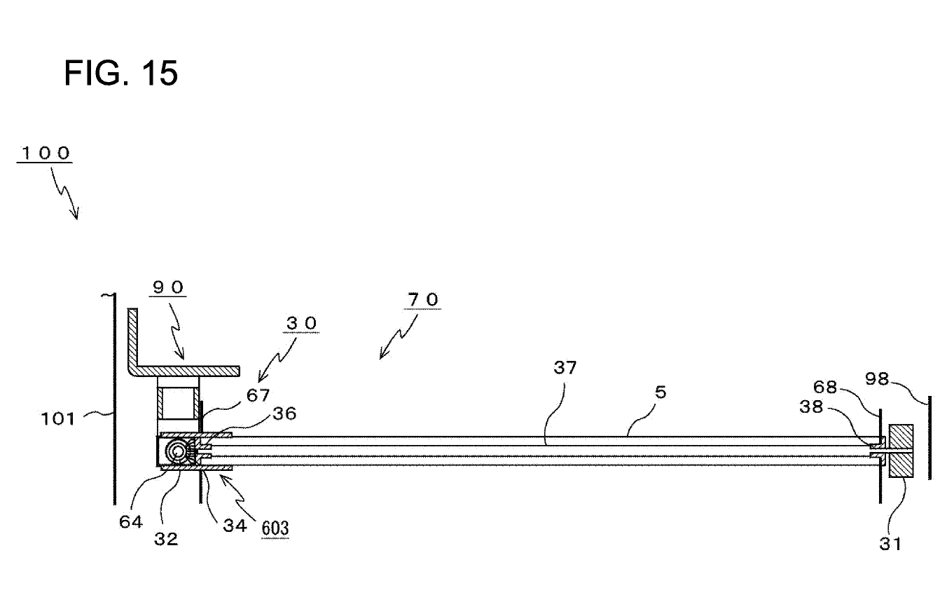

Referring to FIGS. 15 through 17, the following describes an example of the operation of the stopper link mechanism 30 (Nos. 1 through 3). In this example, when the intermediate transfer unit 70 is opened, the stopper link mechanism 30 is interlocked with the pressure member 31 in such a way that the opening operation of the intermediate transfer unit 70 is restricted to the position immediately before collision with the main body 101.

In the stopper link mechanism 30 of FIG. 15 based on the aforementioned operating conditions, the intermediate transfer unit 70 is kept closed. This shows that the composite unit 201 consisting of an intermediate transfer unit 70 and rack unit 90 is pulled out of the main body 101 to the outside so that the intermediate transfer unit 70 can be opened. The opening operation of the relevant intermediate transfer unit 70 has not yet been performed.

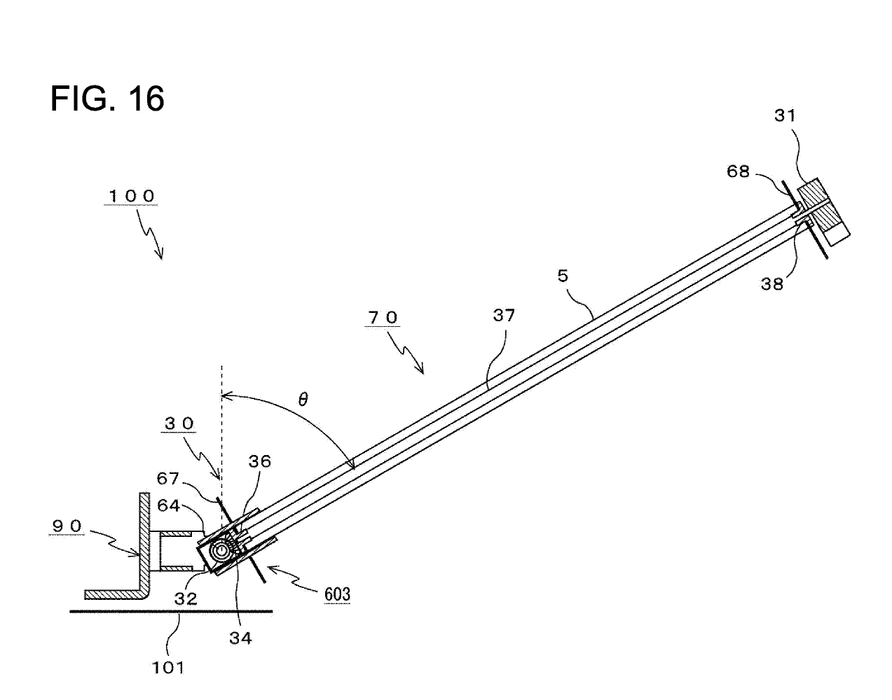

In the stopper link mechanism 30 of FIG. 16, the intermediate transfer unit 70 of FIG. 15 is located at a half-closed position through the closed position, wherein the angle θ of the drawing is 60 degrees, for example. The angle θ indicates the angle formed between this closed position and the position wherein the intermediate transfer unit 70 is opened at a desired degree, with reference to the position wherein the intermediate transfer unit 70 is closed.

The rotary hinge section 603 allows the stopper link mechanism 30 to start interlocked driving between the rotary fulcrum shaft 64 and pressure member 31, so that the unit rotary angle is converted into the rotational displacement of the pressure member 31. As a result, the pressure member 31 is also turned by angle θ=60 degrees. To put it another way, the stopper link mechanism 30 starts interlocked driving of the pressure member 31 based on the angle θ for opening the intermediate transfer unit 70, so that the relevant pressure member 31 is also turned by angle θ (FIG. 13)

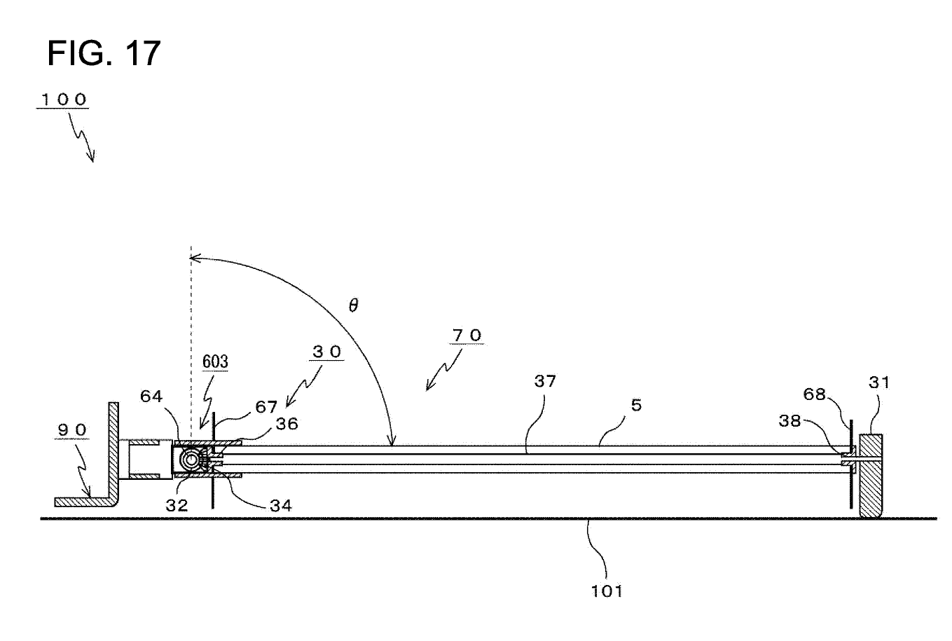

In the stopper link mechanism 30 of FIG. 17, the intermediate transfer unit 70 is further rotated from the angle θ=60 degrees shown in FIG. 16 so that the intermediate transfer unit 70 is fully opened (θ=90 degrees). In this case, the pressure member 31 protrudes from the frame member 5 to abut on the main body 101. Thus, the opening operation of the intermediate transfer unit 70 is restricted to the position immediately before collision between the pressure member 31 and the main body 101, with the result that the intermediate transfer belt 6 is protected.

As described above, a stopper link mechanism 30 is incorporated in the color printer 100 of the third Example, an intermediate transfer unit 70 which, together with the rack unit 90, is removed from or inserted into the main body 101 and which can be opened or closed like a door in the horizontal direction. Thus, the pressure member 31 is driven in an interlocked mode by the stopper link mechanism 30 to regulate the degree of opening of the relevant intermediate transfer unit 70.

When the intermediate transfer unit 70 is opened with respect to the main body 101, this regulating structure restricts the degree of opening of the intermediate transfer unit 70 to the position immediately before collision with the main body 101. This arrangement avoids interference between the main body 101 and intermediate transfer unit 70 without causing any problem in the replacement of a belt. Moreover, the pressure member 31 provides a stopper function by protruding from the position that contains the intermediate transfer belt 6. Thus, the intermediate transfer belt 6 can be protected when the intermediate transfer unit 70 is opened.

### EXAMPLE 4

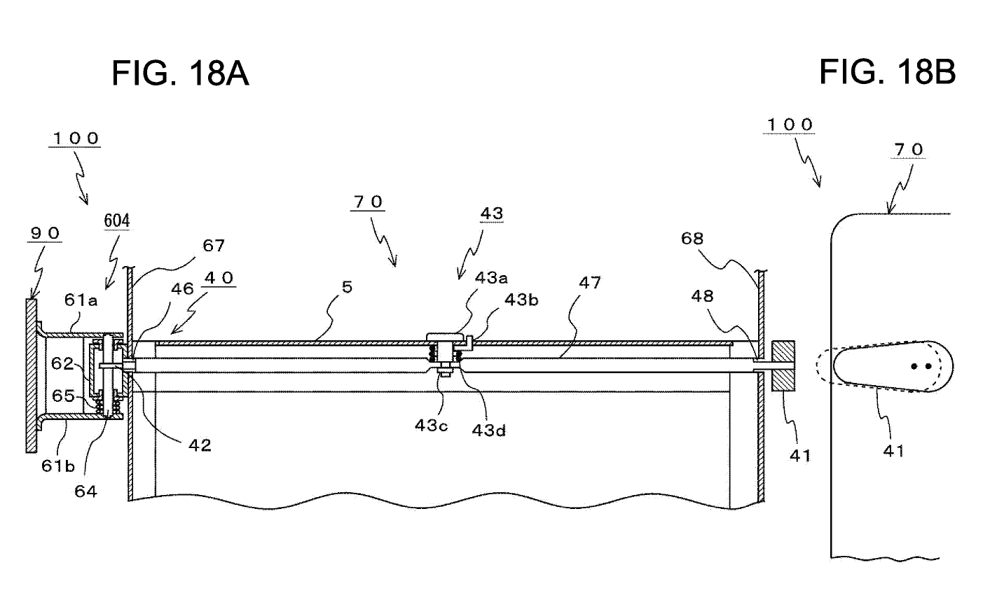

Referring to FIG. 18 through FIG. 22, the following describes the stopper link mechanism 40 of a color printer 100 in a fourth Example. In this example, when the intermediate transfer unit 70 is opened as explained with reference to the first and second Examples, the principle of a lever based on the torque of the rotary hinge section 604 is employed to move the pressure member 41. This allows the pressure member 41 to protrude from the position that interferes with the main body 101 and contains the intermediate transfer belt 6.

The color printer 100 of FIG. 18A includes a pressure member 41, and a stopper link mechanism 40 constituting an example of the second link mechanism, in addition to the intermediate transfer unit 70 described with reference to the first and second Examples. The stopper link mechanism 40 has a stopper pin 42, rotary fulcrum section 43, arm support holders 46 and 48, and arm member 47, whereby an interlocking section is formed. In this example, the stopper link mechanism 40 moves the pressure member 41 to the unit interference limit position. The unit interference limit position in the sense in which it is used here refers to the limit position immediately before the intermediate transfer belt 6 interferes with the main body 101, when the intermediate transfer unit 70 has been opened.

The pressure member 41 forms another example of the opening regulation member 21 of FIG. 9, and regulates the degree of opening of the relevant intermediate transfer unit 70. For example, the pressure member 41 protrudes from the position which interferes with the main body 101 and contains the intermediate transfer belt 6, when the relevant intermediate transfer unit 70 opens with respect to the main body 101 described with reference to the first and second Examples.

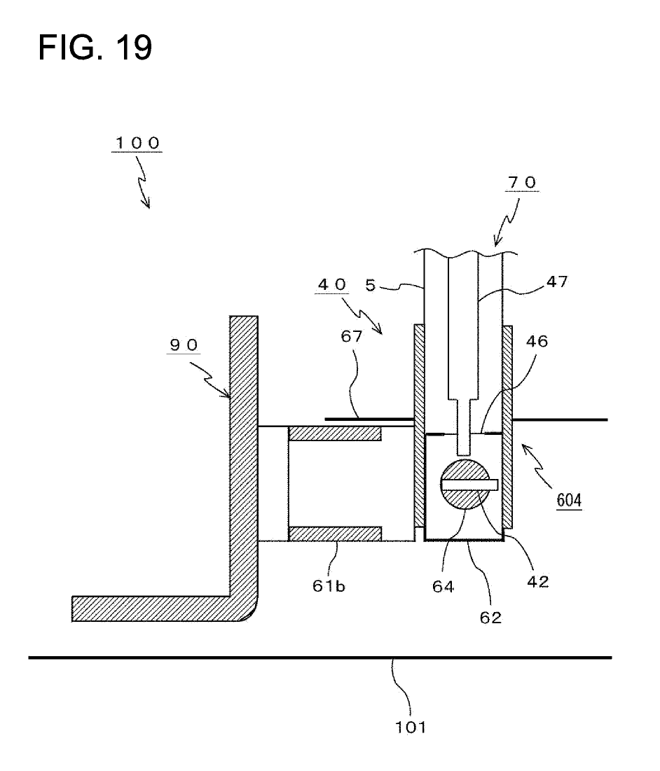

The rotary hinge section 604 of FIG. 18A constitutes an interlocking section. Interlocked with the opening and closing operation of the intermediate transfer unit 70, the rotary hinge section 604 causes the pressure member 41 to protrude. The rotary fulcrum shaft 64 of the rotary hinge section 604 is equipped with a stopper pin 42 of FIG. 19. For example, the rotary fulcrum shaft 64 is equipped with a pin hole (not illustrated). A stopper pin 42 is inserted into this pin hole so that the stopper pin 42 is fixed onto the rotary fulcrum shaft 64.

An aim support holder 46 is provided on the side of the bearing support member 62 perpendicular to the rotary fulcrum shaft 64 on the rotary hinge section 604. In the arm support holder 46, one end of the arm member 47 (balancing beam) is processed into a slender rod. Movement occurs as one end of the arm member 47 processed into a slender rod abuts on the stopper pin 42. The aim support holder 46 is made up of a slot and extends from the side of the bearing support member 62 to the intermediate transfer rear panel 67. The slender end of the arm member 47 is engaged so as to be rocked freely.

In this example, almost the central portion of the arm member 47 of FIG. 18A is subjected to stamping operation. A shaft hole (not illustrated) is formed on the central portion of the stamped arm member 47 and serves as a rotary fulcrum 43. The rotary fulcrum 43 includes an arm fulcrum member 43a, arm regulation spring 43b, fixing member 43c and oscillating spring 43d. The arm fulcrum member 43a has a rod-formed portion and is installed on a prescribed position of the frame member 5.

The rod-formed portion of the arm fulcrum member 43a further penetrates the shaft hole (not illustrated) on the central portion of the aim number 47 through the aim regulation spring 43b. The arm member 47 is biased by the arm regulation spring 43b in a prescribed direction. The rod-formed portion of the arm fulcrum member 43a is fixed in position by the fixing member 43c. This arrangement ensures the arm member 47 to be freely rotated with reference to the rotary fulcrum 43.

In the meantime, the other end of the arm member 47 penetrates the intermediate transfer front panel 68. A slot (not illustrated) is formed on the portion of the intermediate transfer front panel 68 penetrated by the other end of the arm member 47. This slot constitutes an arm support holder 48. The arm support holder 48 is engaged in position in such a way that the other end of the arm member 47 can be rocked freely. The other end of the aim member 47 is fitted with a pressure member 41 having a shape shown in FIG. 18B (spindle-shaped). This arrangement constitutes a stopper link mechanism 40. The pressure member 41 is moved in a prescribed direction by the stopper pin 42 of the rotary fulcrum shaft 64.

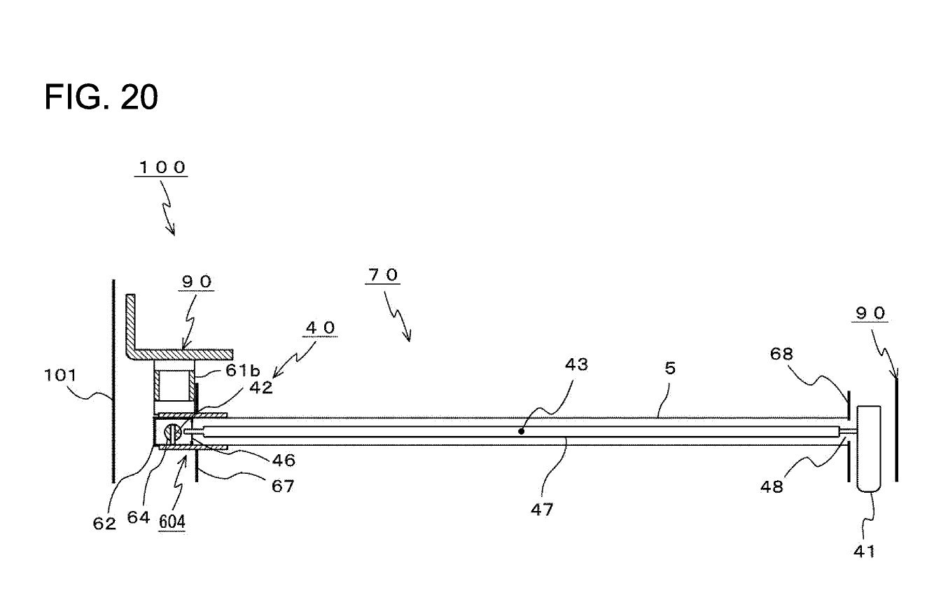

Referring to FIG. 20 through FIG. 22, the following describes an example of the operation of the stopper link mechanism 40 (Nos. 1 through 3) of a color printer 100. In this example, when the intermediate transfer unit 70 is opened, the stopper link mechanism 40 is interlocked with the pressure member 41 in such a way that the opening operation of the intermediate transfer unit 70 is restricted to the position immediately before collision with the main body 101.

In the stopper link mechanism 40 of FIG. 20 based on the aforementioned operating conditions, the intermediate transfer unit 70 is kept closed. This shows that the composite unit 201 consisting of an intermediate transfer unit 70 and rack unit 90 is pulled out of the main body 101 to the outside so that the intermediate transfer unit 70 can be opened. The opening operation of the relevant intermediate transfer unit 70 has not yet been performed.

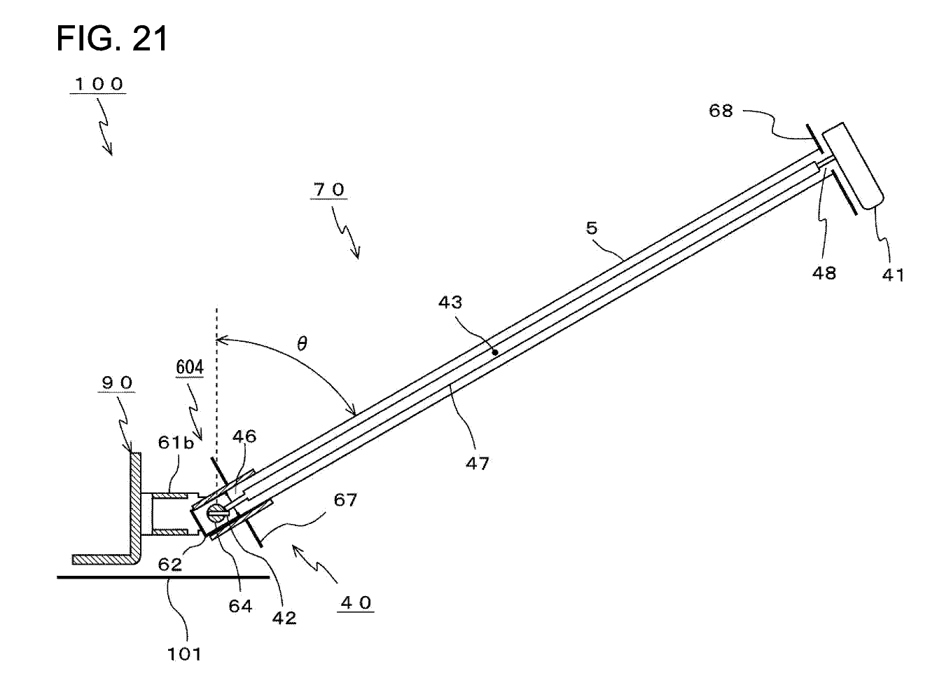

In the stopper link mechanism 40 of FIG. 21, the intermediate transfer unit 70 is located at a half-closed position through the closed position shown in FIGS. 18A, 1813 and 20, wherein the angle θ of the drawing is 60 degrees, for example. The angle θ indicates the angle formed between this closed position and the position wherein the intermediate transfer unit 70 is opened at a desired degree with reference to the position wherein the intermediate transfer unit 70 is closed.

The rotary hinge section 604 allows the stopper link mechanism 40 to move the pressure member 41 using the principle of a lever based on the torque of the rotary hinge section 64, wherein the abutting section formed by the stopper pin 42 and the end of the arm member 47 is a power point, rotary fulcrum 43 is a fulcrum, and the pressure member 41 is a point of action. This operation converts the rotary motion of the intermediate transfer unit 70 into the protrusion of the pressure member 41.

In this example, when the intermediate transfer unit 70 has turned only “angle θ=60 degrees”, the pressure member 41 remains unchanged, unlike the pressure member 31 in the third Example. To put it another way, in the stopper link mechanism 40, the stopper pin 42 has not yet reached one end of the arm member 47 in the arm support holder 46. From this position, the user operates to open the intermediate transfer unit 70 further.

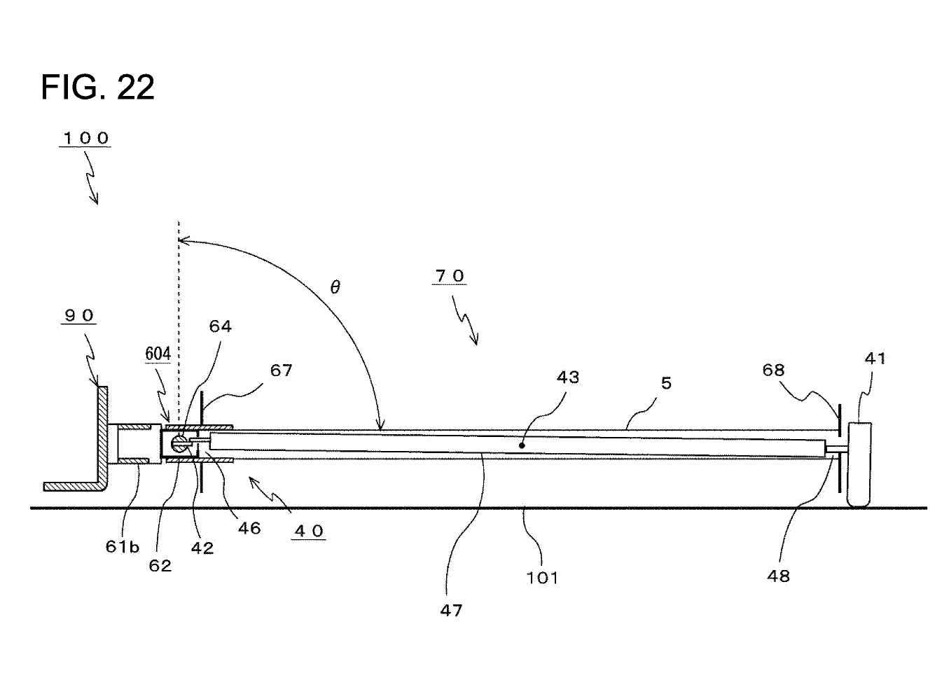

In the stopper link mechanism 40 of FIG. 22, the intermediate transfer unit 70 is opened from angle θ=60 degrees shown in FIG. 21 so that the intermediate transfer unit 70 has come very close to being fully opened (θ=90 degrees). In this case, in the arm support holder 46, the stopper pin 42 has reached one end of the arm member 47 and the stopper pin 42 abuts on one end of the arm member 47.

In this example, when an abutting force greater than the biasing force of the oscillating spring 43d has been given to the arm member 47 by the stopper pin 42, the stopper pin 42 moves one end of the arm member 47. This movement allows the pressure member 41 to protrude from the frame member 5 and to abut on the main body 101. This arrangement ensures the opening operation of the intermediate transfer unit 70 to be restricted to the position immediately before collision between the pressure member 41 and the main body 101.

As described above, in the color printer 100 of the fourth Example, the pressure member 41 is moved to the unit interference limit position by the stopper link mechanism 40 provided with an intermediate transfer unit 70 which, together with the rack unit 90, is removed from or inserted into the main body 101 and which can be opened or closed like a door in the horizontal direction, wherein the stopper link mechanism 40 constitutes an interlocking section.

When the intermediate transfer unit 70 is opened with respect to the main body 101, this regulating structure ensures the opening operation of the intermediate transfer unit 70 to be regulated to the position immediately before collision with the main body 101. This avoids interference between the main body 101 and intermediate transfer unit 70, without causing trouble during belt replacement. Moreover, the transfer belt 6 can be protected when the intermediate transfer unit 70 is opened.

### EXAMPLE 5

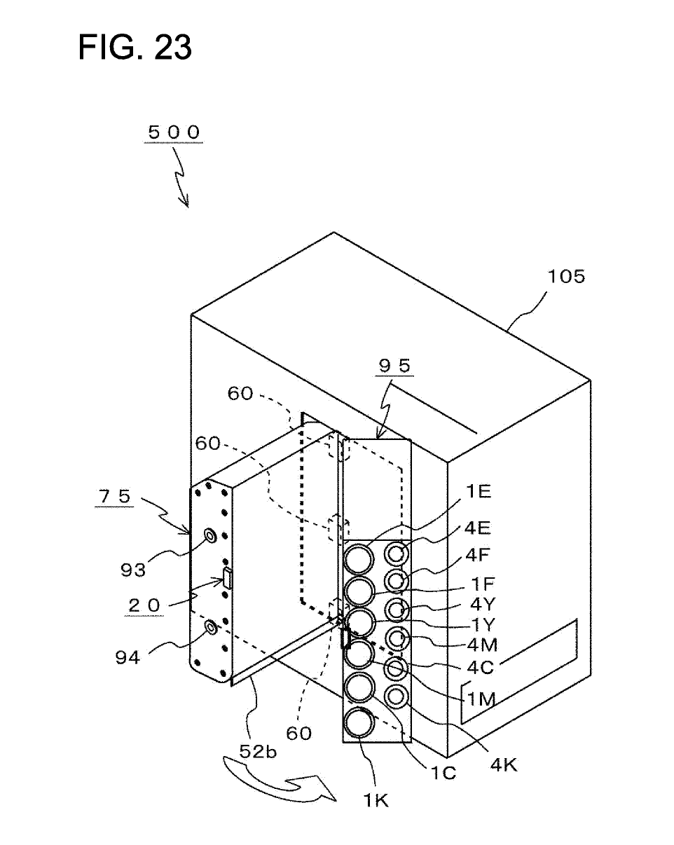

Referring to FIG. 23, the following describes an example of opening or closing the rack unit 95 of the color printer 500 in the fifth Example. The color printer 500 of FIG. 25 includes an intermediate transfer unit 75, rack unit 95 and main body 105. Similarly to the case of the first through fourth Examples, the rack unit 95, together the intermediate transfer unit 75, can be removed from or inserted into the main body 105, and can be opened or closed like a door in the horizontal direction.

The main body 105 has an image forming rack unit 95 that can be removed from the main body 105, and an intermediate transfer unit 75 that can be removed or inserted at the same time. The rack unit 95 is mounted inside the main body 105, and forms a color image. The intermediate transfer unit 75 transfers the color image formed by the rack unit 95. The rack unit 95, together with the intermediate transfer unit 75, can be removed from or inserted into the main body 105, and can be opened or closed like a door in the horizontal direction.

In this example, a pair of rail members 52h (only one is illustrated) are provided below the intermediate transfer unit 75, and a rail member (not illustrated) is provided on the left of the intermediate transfer unit 75. The rotary hinge section 60 described with reference to FIG. 3 is provided on the furthest side of the intermediate transfer unit 75. A rack unit 95 is mounted on this rotary hinge section 60. Unlike the one in the first through fourth Examples, the rack unit 95 is installed in such a way as to be opened or closed like a door in the horizontal direction with reference to the intermediate transfer unit 75, through the rotary hinge section 60 (door-like open/close structure).

Adoption of this door-like open/close structure ensures the photoreceptor drums 1E, 1F, 1Y, 1M, 1C and 1K to be replaced, without the rack unit 95 being removed from the main body 105. It goes without saying that the temporary fixing mechanism 20 described with reference to the second Example and the stopper link mechanisms 30 and 40 described with reference to the third and fourth Examples can be applied to the rack unit 95.

The color printer 500 of the fifth Example is provided with an image forming rack unit 95 that can be removed from or inserted into the main body 105. This rack unit 95 together with the intermediate transfer unit 75 can be removed from or inserted into the main body 105, and can be opened or closed like a door in the horizontal direction. When the photoreceptor drums 1E, 1F, 1Y, 1M, 1C and 1K are to replaced, this structure ensures the rack unit 95 to be opened or closed like a door with reference to the intermediate transfer unit 75, while the rack unit 95 is kept pulled out of the main body 105. Thus, this structure permits the photoreceptor drums 1E, 1F, 1Y, 1M, 1C and 1K to be replaced, without having to dismount from the main body 105 the rack unit 95 that may be difficult to remove due to an increase in the size of the color printer 500.

In the above description of the color printer 500, the rack unit 95 can be opened or closed in the horizontal direction like a door with reference to the intermediate transfer unit 75, through the rotary hinge section 60 provided on the furthest side of the intermediate transfer unit 75. However, the present invention is not restricted thereto.

For example, a rotary hinge section 60 can be installed on the nearest side of the intermediate transfer unit 75, and this rotary hinge section 60 can be provided with a rack unit 95 so that the rack unit 95 can be opened or closed in the horizontal direction like a door with reference to the intermediate transfer unit 75. When this structure is adopted, the photoreceptor drums 1E, 1F, 1Y, 1M, 1C and 1K can also be replaced, without the rack unit 95 being removed from the main body 105.

What is claimed is:

1. A color image forming apparatus comprising:
a main body of the apparatus that forms a color image; and
an intermediate transfer unit for transferring the color image famed by the main body of the apparatus,
wherein the intermediate transfer unit is configured to be removed from and to be inserted into the main body of the apparatus, and wherein the intermediate transfer unit is configured to perform a door-like opening and closing movement.

2. The color image forming apparatus of claim 1, wherein the main body of the apparatus comprises a rack unit for image forming which, together with the intermediate transfer unit, configured to be removed from and inserted into the main body apparatus.

3. The color image forming apparatus of claim 2, wherein the intermediate transfer unit is mounted in such a way as to perform a door-like opening and closing movement in the horizontal direction through a rotary hinge section provided on a back side of the rack unit.

4. The color image forming apparatus of claim 2, wherein the intermediate transfer unit is mounted in such a way as to perform a door-like opening and closing movement in the horizontal direction through the rotary hinge section provided on a front side of the rack unit.

5. The color image forming apparatus of claim 3, wherein a gap adjusting play for adjusting a position gap between the intermediate transfer unit and the rack unit in a vertical direction and a lateral direction is arranged.

6. The color image forming apparatus of claim 5, wherein a temporary fixing mechanism is installed between the rack unit and the intermediate transfer unit, and the temporary fixing mechanism is provided with the gap adjusting play.

7. The color image forming apparatus of claim 6, wherein the temporary fixing mechanism further comprises a magnetic member mounted on the rack unit for attracting the intermediate transfer unit, and the magnetic member comprises a gap adjusting play for adjusting a position gap between the intermediate transfer unit and the rack unit in a unit attracting direction which is assumed as a direction of attracting the intermediate transfer unit.

8. The color image forming apparatus of claim 7, wherein the temporary fixing mechanism is provided with a function of adjusting the position gap in the unit attracting direction.

9. The color image forming apparatus of claim 2, wherein the rotary hinge section is installed on each of top and bottom of the back side of the rack unit, and each of the rotary hinge sections on the top and bottom is provided with a positioning gap absorbing damper member.

10. The color image forming apparatus of claim 2, wherein the main body of apparatus comprises a rear panel and the intermediate transfer unit comprises a front panel, wherein a plurality of penetration shafts for positioning are fixed at prescribed positions of the rear panel and a plurality of bearing sections for positioning are provided at prescribed positions of the front panel at which each top of the plurality of penetration shafts are exposable, and wherein the color image forming apparatus being provided with a positioning mechanism in which each top end of the exposed penetration shafts is engaged with the bearing sections or a plurality of engaging members are engaged with the bearing sections.

11. A color image forming apparatus comprising:
a main body;
a rack unit installed in the main body for color image forming; and
an intermediate transfer unit for transferring the color image formed by the rack unit,
wherein the rack unit is configured to be removed from and to be inserted into the main body of the apparatus, and wherein the rack unit is configured to perform a door-like opening and closing movement.

12. The color image forming apparatus of claim 11, wherein the rack unit is mounted in such a way as to be opened and closed freely like a door in the horizontal direction through a rotary hinge section provided on a furthest side of the intermediate transfer unit.

13. The color image forming apparatus of claim 11, wherein the rack unit is mounted in such a way as to be opened and closed freely like a door in the horizontal direction through a rotary hinge section provided on a front side of the intermediate transfer unit.

14. The color image forming apparatus of claim 1, further comprising an opening amount regulating member for regulating an opening amount of the intermediate transfer unit.

15. The color image forming apparatus of claim 14 wherein, when the intermediate transfer unit is opened from the main body of the apparatus, the opening amount regulating member projects from a position at which regulating member is contained within a transfer belt of the intermediate transfer unit and interferes with the main body of the apparatus.

16. The color image forming apparatus of claim 15, further comprising an interlocking section for projecting the opening amount regulating member synchronously with an opening/closing operation of the intermediate transfer unit.

17. The color image forming apparatus of claim 16, wherein the interlocking section includes a first link mechanism for rotating the opening amount regulating member according to an angle for opening the intermediate transfer unit.

18. The color image forming apparatus of claim 16, wherein the interlocking section includes a second link mechanism for moving the opening amount regulating member to a unit interference limit position, wherein the unit interference limit position corresponds to a limit position at which the intermediate transfer member does not interfere with the main body of the apparatus in a case where the intermediate transfer unit is opened.
